(19) United States
(12) Patent Application Publication
(10) Pub. No.: US 2013/0133913 A1
(43) Pub. Date: May 30, 2013

(54) Force-Barrier

(71) Applicants: Hadar Magali, Breda (NL); Shachar Magali, Drimmelen (NL)

(72) Inventors: Hadar Magali, Breda (NL); Shachar Magali, Drimmelen (NL)

(21) Appl. No.: 13/637,067

(22) PCT Filed: Mar. 23, 2011
(86) PCT No.: PCT/NL2011/000022

§ 371 Date: Nov. 27, 2012

(30) Foreign Application Priority Data
Mar. 25, 2010 (NL) PCT/NL2010/000056

(51) Int. Cl. B25D 17/00

(52) U.S. Cl. CPC B25D 17/00
USPC 173/210

(57) ABSTRACT

The Force-Barrier is a very fast force applier and remover on or from a reciprocating body. The Force-Barrier is a completely passive device. It needs no control, and switches the force always at the same location regardless the orientation and gravity. In case the reciprocating body is driven by pressurized liquid or compressed gas, the Force-barrier is a substitute to a directional valve, or on-off valve, but faster, consuming less energy, and not being in need of control. The Force-Barrier enables the use of at least one spring and/or at least one electro motor in rebound-effectors and other reciprocating devices. The Force-Barrier may be implemented as a disk placed in between a cylinder and a piston, wherein the cylinder has two internal diameters, and the piston has two external diameters, and wherein there is a step between the two diameters of the piston and the two diameters of the cylinder.

### FIELD OF THE INVENTION

The present invention relates to a Force-Barrier which, very fast, loads and/or unloads a force, or forces, on or from a reciprocating body. The Force-Barrier improves the functionality of any reciprocating-mass-based device. It may be applied for linear motors, linear actuators, linear vibrators, angular reciprocating motors, angular reciprocating actuators, angular reciprocating vibrators, and rebound-effectors.

In case of rebound-effectors, the Force-Barrier dramatically improves performance and capacities. The high speed switching, passive behavior, high flow capacity, and compressed gas use allow an open variety of applications. Driving hammers, vibrating hammers, compacting hammers, crushers, and force multipliers are just a few to mention.

The use for Force-Barrier-based machines, or devices, is in general industry, foundation industry, earth moving equipment, heavy equipment, hand-held tools, farming, medicine, dental, sensors, home apparatuses, mining, construction, and, virtually, in any other discipline.

### BACKGROUND OF THE INVENTION

For the rebound-effector functionality, the switching time is very important. As the switching time will be shorter, the efficiency, and the effectiveness, will be higher. An extremely fast force direction changer is needed. A rebound-effector may be involved with a high pressurized fluid flow rate. In such a case, the valve which changes the active force direction on the moving part has to deal with a high pressurized fluid flow, which means that it has to be a big valve. The rebound-effector has tens of cycles per second. In case of pressurized fluid use, the control valve has to have tens of cycles per second, which means a lot of energy consumption for the valve functionality.

The combination of short switching time, high flow, and high rate of switching is very difficult to be realized. The common spool valves, as well as the common poppet valves, have no capacity to deal with those demands. The above common valves have no capacity to separately deal with fast switching, high flow, or high rate of switching. In case the rebound-effector is driven by springs, there is no known technique to quickly switch the force from one direction to the opposite direction. The same is with electric motors, and linear electric motors.

There are a lot of different kinds of valves on the market. Those valves may apply or remove liquid or gas pressure. For doing this, a solid body has to change position, or to move. This movement takes time, so the implementation or the removal of the pressure takes time as well. Very fast valves need about five milliseconds to perform a full swing from fully open to fully closed, or vice versa. As the moving solid body of the valve has mass, which has to be highly accelerated, energy is needed to perform the movement. The very fast valves are, on the one hand, not fast enough, and, on the other hand, large energy consumers.

There are valves for fast switching, for high flow, or for high frequency. When it comes to high flow, which is combined with very fast, and very frequent switching, there is no commercial solution available. The situation is even worse—it is not a matter of price, or demand—the existing knowledge does not support high frequent, fast switching of high flow.

There are a lot of patents regarding valves' structure, and valves' control—but all of them are based on movement and/or rotation of a solid body. The solid body needs time, and consumes energy, for its position change. The reality is that as the flow is higher, the moving solid body is bigger, and heavier. As the switching time is lower, the control force is higher, and as the switching rate is higher, the energy consumption is higher. In the present case all of a high flow, a low switching time, and a high frequency are needed. None of the patents deals with such combination.

The existing flow valves have the capacity to allow full flow, limited flow, or to avoid flow—but they have no capacity to apply or to remove force caused by pressurized media without changing the effective volume of the media. In order to build up force, the valve has to expose the effective area with pressurized media. In order to keep the force, the valve has to add pressurized media as the effected body moves. In order to allow movement to the other direction, the flow valve has to drain what was previously pressurized media into a low pressure container. Thus, the flow valve delivers high pressurized media in order to drive a body to one direction, and then delivers the same volume to a low pressurized container. As the flow valve functions, the media is cycled from high to low pressure. This cycling limits the use of gases, as a lot of energy is wasted just by the compressing-releasing-compressing process.

The media cycling is problematic for the rebound-effector. The cycling prevents the option to isolate the energy converter from the other functions, and to let it be an autonomic function, and autonomic mechanism. The energy converter converts driving energy into kinetic energy, and kinetic energy into driving energy. In case the driving energy is pressurized media, the use of a flow valve dictates high pressure flow to the energy converter, and then splitting that flow to low pressure. The flow splitting to a low pressure chamber eliminates the use of compressed gases, and reduces the efficiency of the pressurized-liquid-based system.

For the option according to which the rebound-effector is driven totally or partly by at least one spring, the common flow valves are not relevant at all. A mechanical barrier is needed.

If the rebound-effector is driven totally or partly by any kind of electric motor, the polarity of the motor as well as a connection to the power supply may easily be changed by common mosfet transistors. The mosfet transistor functions very fast, but it takes more than five milliseconds for the coils of the electric motor to change their polarity. The real switching time of the electric motor is too long. A mechanical barrier is needed.

A solution, which will allow high media flow, low switching time, high switching frequency, and autonomic energy converter, with the option to be assisted or operated by (a) spring(s) and/or by (an) electric motor(s) is needed.

### SUMMARY OF INVENTION

The present invention provides a realistic method and realistic apparatuses, which is an alternative for very fast pressurized media flow switching.

The present invention provides a realistic method and realistic apparatuses, which is an alternative for high flow pressurized media flow switching.

The present invention provides a realistic method and realistic apparatuses, which is an alternative for high frequency pressurized media flow switching.

The present invention provides a realistic method and realistic apparatuses, which is an alternative for the combination of very fast flow switching, high flow switching, and high frequency switching.

The present invention provides a realistic method and realistic apparatuses for very fast and/or very frequent spring load applying and removal.

The present invention provides a realistic method and realistic apparatuses for very fast and very frequent magnetic and/or electro-magnetic, and/or electric load applying, and/or removal.

The present invention provides a realistic method and realistic apparatuses for separating the energy converter of a rebound-effector from the other functions.

The present invention provides a realistic method and realistic apparatuses for creating an isolated, autonomic energy converter for a rebound-effector.

The present invention provides a realistic method and realistic apparatuses for running and/or controlling linear motors and/or linear actuators.

The present invention provides a realistic method and realiStic apparatuses for running and/or controlling angular reciprocating motors and/or angular reciprocating actuators.

The present invention provides a realistic method and realistic apparatuses, which can be driven by virtually any commercial energy source.

The present invention provides a realistic method and realistic apparatuses, which can be realized by very small to very big devices.

The present invention provides a realistic method and realistic apparatuses, which can be applied to virtually any discipline.

### BRIEF DESCRIPTION OF THE DRAWINGS

FIG. 1a shows a Force-Barrier, as being applied in a rebound-effector, energized by pressurized liquid and/or compressed gas, at both sides of the piston. The piston is shown at the right side of the rest position, or switching point. The Force-Barrier is pushed to the right by the pressure of the pressurized liquid and/or by the pressure of the compressed gas.

FIG. 1b shows a Force-Barrier, as being applied in a rebound-effector, energized by pressurized liquid and/or compressed gas, at both sides of the piston. The piston is shown at the rest position, or switching point. The Force-Barrier is pushed to the right by the pressure of the pressurized liquid and/or by the pressure of the compressed gas.

FIG. 1c shows a Force-Barrier, as being applied in a rebound-effector, energized by pressurized liquid and/or compressed gas, at both sides of the piston. The piston is shown at the left side of the rest position, or switching point. The Force-Barrier is pushed to the right by the pressure of the pressurized liquid and/or by the pressure of the compressed gas.

FIG. 2a shows two Force-Barriers, as being applied in a rebound-effector, energized by pressurized liquid and/or compressed gas, at both sides of the piston. The piston is shown at the right side of the rest position, or switching point. The Force-Barriers are pushed to the right and to the left by the pressure of the pressurized liquid and/or by the pressure of the compressed gas.

FIG. 2b shows two Force-Barriers, as being applied in a rebound-effector, energized by pressurized liquid and/or compressed gas, at both sides of the piston. The piston is shown at the rest position, or switching point. The Force-Barriers are pushed to the right and to the left by the pressure of the pressurized liquid and/or by the pressure of the compressed gas.

FIG. 2c shows two Force-Barriers, as being applied in a rebound-effector, energized by pressurized liquid and/or compressed gas, at both sides of the piston. The piston is shown at the left side of the rest position, or switching point. The Force-Barriers are pushed to the right and to the left by the pressure of the pressurized liquid and/or by the pressure of the compressed gas.

FIGS. 3a, 3b and 3c show a Force-Barrier, as being applied in a rebound-effector, energized by a spring, at both sides of the piston. The piston is shown at the right side of the rest position, at the rest position, and at the left side of the rest position. The Force-Barrier is pushed to the right by the force of the spring.

FIGS. 4a, 4b and 4c show two Force-Barriers, as being applied in a rebound-effector, energized by a spring, at both sides of the piston. The piston is shown at the right side of the rest position, at the rest position, and at the left side of the rest position. The Force-Barriers are pushed to the right and to the left by the springs.

FIGS. 5a, 5b and 5c show two Force-Barriers, as being applied in a rebound-effector, energized by different spring combinations at both sides of the piston. The piston is shown at the rest position, or switching point.

FIG. 6a shows two Force-Barriers, as being applied in a rebound-effector. The left side of the piston is energized by pressurized liquid and/or by compressed gas. The right side of the piston is energized by a spring. The piston is shown at the rest position, or switching point. The left Force-Barrier is pushed to the right by the pressure of the pressurized liquid and/or by the pressure of the compressed gas, and the right Force-Barrier is pushed to the left by the spring.

FIG. 6b shows a Force-Barrier, as being applied in a rebound-effector. The right side of the piston is energized by pressurized liquid and/or by compressed gas. The left side of the piston is energized by a spring. The piston is shown at the rest position, or switching point. The Force-Barrier is pushed to the right by the spring.

FIG. 6c shows a Force-Barrier, as being applied in a rebound-effector. The left side of the piston is energized by pressurized liquid and/or by compressed gas. The right side of the piston is energized by a spring. The piston is shown at the rest position, or switching point. The Force-Barrier is pushed to the right by the pressure of the pressurized liquid and/or by the pressure of the compressed gas.

FIG. 7a shows a Force-Barrier, as being applied in a rebound-effector. The left side of the piston is energized by a spring. The right side of the piston is energized by an electro magnet. The piston is shown at the rest position, or switching point. The Force-Barrier is pushed to the right by the spring.

FIG. 7b shows a Force-Barrier, as being applied in a rebound-effector. The left side of the piston is energized by pressurized liquid and/or by compressed gas. The right side of the piston is energized by an electro magnet. The piston is shown at the rest position, or switching point. The Force-Barrier is pushed to the right by the pressure of the pressurized liquid and/or by the pressure of the compressed gas.

FIGS. 8a, 8b, 8c and 8d show three Force-Barriers, as being applied in a rebound-effector. Two Force-Barriers push the piston to the right by pressurized liquid and/or by compressed gas. One Force-Barrier pushes the piston to the left by a spring. The piston is shown in four significant positions.

FIG. 9a shows two Force-Barriers, as being applied in a rebound-effector. The left side of the piston is energized by a spring. The right side of the piston is energized by a moving magnet motor. The piston is shown at the rest position, or switching point. The left Force-Barrier is pushed to the right by the spring. The right Force-Barrier, which is a magnet, is pushed to the left by the coil of the moving magnet motor.

FIG. 9b shows two Force-Barriers, as being applied in a rebound-effector. The left side of the piston is energized by pressurized liquid and/or compressed gas. The right side of the piston is energized by a moving magnet motor. The piston is shown at the rest position, or switching point. The left Force-Barrier is pushed to the right by the pressurized liquid and/or the compressed gas. The right Force-Barrier, which is a magnet, is pushed to the left by the coil of the moving magnet motor.

FIG. 10a shows a Force-Barrier, as being applied in a rebound-effector. The left side of the piston is energized by a spring. The right side of the piston is energized by a moving magnet motor. The piston is shown at the rest position, or switching point. The Force-Barrier is pushed to the right by the spring. The magnet of the moving magnet motor is integrated in the piston.

FIG. 10b shows a Force-Barrier, as being applied in a rebound-effector. The left side of the piston is energized by pressurized liquid and/or compressed gas. The right side of the piston is energized by a moving magnet motor. The piston is shown at the rest position, or switching point. The Force-Barrier is pushed to the right by the pressurized liquid and/or the compressed gas. The magnet of the moving magnet motor is integrated in the piston.

FIG. 11 shows a Force-Barrier, as being applied in a rebound-effector. Both sides of the piston are energized by moving magnet motors. The piston is shown at the rest position, or switching point. The Force-Barrier, which is the magnet of the left moving magnet motor, is pushed to the right by the left coil. The magnet of the right moving magnet motor is integrated in the piston.

FIGS. 12a, 12b and 12c show two Force-Barriers, as being applied in a rebound-effector. Both sides of the piston are energized by a spring. An electro magnet is integrated to the left side of the cylinder, in order to add or to reduce energy to or from the piston. The piston is shown in the three significant positions.

FIGS. 13a, 13b and 13c show two Force-Barriers, as being applied in a rebound-effector. Both sides of the piston are energized by a spring. A moving magnet motor is integrated to the central part of the cylinder, in order to add or to reduce energy to or from the piston. The piston is shown in the three significant positions.

FIGS. 14a, 14b and 14c show two Force-Barriers, as being applied in a rebound-effector. Both sides of the piston are energized by a spring. A moving magnet motor is attached to the right part of the cylinder, and effects the right spring, in order to add or to reduce energy to or from the piston. The piston is shown in the three significant positions.

FIGS. 15a, 15b and 15c show two Force-Barriers, as being applied in a rebound-effector. Both sides of the piston are energized by a spring. A moving magnet motor is attached to the left side of the cylinder. The magnet of the moving magnet motor is integrated into the piston. The moving magnet motor adds or reduces energy to or from the piston. The piston is shown in the three significant positions.

FIGS. 16a, 16b and 16c show a Force-Barrier, as being applied in a rebound-effector. Both sides of the piston are energized by compressed gas. The left chamber and the right chamber are connected each other. The piston is shown in the three significant positions.

FIG. 17 shows a Force-Barrier, as being applied in a rebound-effector. Both sides of the piston are energized by pressurized liquid. The left chamber and the right chamber are connected each other. The pressurized liquid is pressurized by compressed gas. The two compressed gas chambers are connected each other.

FIG. 18 shows two Force-Barriers, as being applied in a rebound-effector. Both sides of the piston are energized by compressed gas. The left chamber and the right chamber are connected to each other through the piston.

FIGS. 19a, 19b and 19c show a Force-Barrier, as being applied in a rebound-effector. Both sides of the piston are energized by pressurized liquid. The left chamber and the right chamber are connected to a compressed gas accumulator. The pressurized liquid is pressurized by compressed gas. The piston is shown in the three significant positions.

FIG. 20a shows two Force-Barriers, as being applied in a rebound-effector. Both sides of the piston are energized by compressed gas. The left chamber and the right chamber are connected each other through the piston. The central part is marked as Detail A.

FIG. 20b shows Detail A when the two Force-Barriers are laid on the piston, and on the cylinder, in the rest position, or switching point.

FIG. 20c shows Detail A when the two Force-Barriers are laid on the cylinder, having no contact with the piston, in the rest position, or switching point.

FIG. 20d shows Detail A when the two Force-Barriers are laid on the piston, having no contact with the cylinder, in the rest position, or switching point.

FIG. 20e shows the forces acting on the piston, while crossing the switching point to the right, in case both Force-Barriers lie on the piston, and on the cylinder in the rest position, or switching point.

FIG. 20f shows the forces acting on the piston, while crossing the switching point to the right, in case both Force-Barriers lie just on the cylinder in the rest position, or switching point.

FIG. 20g shows the forces acting on the piston, while crossing the switching point to the right, in case both Force-Barriers lie just on the piston in the rest position, or switching point.

### DETAILED DESCRIPTION OF EMBODIMENTS

The Force-Barrier is a mechanism which, very fast, removes or applies load from or on a reciprocating body. The load removing or applying changes the direction and/or the magnitude of the effective force acting on the reciprocating body. Most of the time, the Force-Barrier reverses the direction of the effective force. Reversing the direction of the effective force reverses the direction of the acceleration, and eventually reverses the movement direction of the reciprocating body.

The Force-Barrier is pushed to one direction by means of at least one spring, pressurized media, electric force, electro-magnetic force, magnetic force, any combination of the mentioned force resources, or any other force. Once the Force-Barrier lies on a moving part, let say a piston, it applies force which pushes the piston. Once the Force-Barrier lies on a static part, let say a cylinder, it applies a force on the cylinder, but has no effect on the piston.

The Force-Barrier may have any shape, may be composed of one or more parts, may serve more functions, and may be made of any material(s). The Force-Barrier has no specific shape, no specific material, nor specific structure, and is not limited to one function, but includes the function of passive, and fast force adding or removal on or from a reciprocating body.

The Force-Barrier may perform at least one more function, rather than force applier or remover. In case pressurized liquid and/or compressed gas pushes the Force-Barrier, the latter serves as part of the pressurized liquid and/or compressed gas chamber and sealing. If a moving magnet motor pushes the Force-Barrier, it may be the magnet of the moving magnet motor. The Force-Barrier may serve as measuring device, or part of a measuring system. The Force-Barrier may include at least one material which improves functionality, control and/or traceability of the system, like lubricants, corrosion protectors, piezoelectric materials, electronic components, energy storage materials, transmitters, receivers, seals, wipers, filters, static balancers, dynamic balancers, magnets, radioactive tracers, chemical tracers, sensors, coils, valves, and/or shock dumpers, and so on.

Most of the time, the Force-Barrier is realized by a floating, passive ring, which may be laid on the moving body and/or on the static body—depending on the relative location of the moving body.

The Force-Barrier may be used for rebound-effectors, angular rebound-effectors, linear motors, angular reciprocating motors, linear actuators, angular reciprocating actuators, linear vibrators, angular reciprocating vibrators, and for any mechanism which has at least one back and forth moving or angular reciprocating part.

For simplicity and consistency, the drawings and the descriptions are using a rebound-effector as the device for which at least one Force-barrier is applied, but the use of the Force-Barrier is not limited to a rebound-effector.

For sake of clarity, and in order to assist in understanding the description and the drawings, a short description of the rebound-effector follows.

A rebound-effector is a mechanism which runs a weight forth and back, by high acceleration. As the weight accelerates, a rebound force is built up. This force is proportional to the product of the weight and the acceleration, and is in opposite direction to the acceleration vector.

The rebound-effector has four operational phases. The energy inserts into the system, during the first phase, accelerates the weight to the same direction as the movement, being converted into kinetic energy. This kinetic energy is taken back during the second phase, while slowing down the weight, and stored. During the third phase, the stored energy accelerates the weight to the moving direction, being converted into kinetic energy. This kinetic energy is taken back during the fourth phase, while slowing down the weight, and stored. Neglecting the friction and the non-ideal behavior of the energy conversion, the rebound-effector needs an external energy source just for compensating for the real, effective, physical work it performs.

The rebound-effector creates rectangular, oscillating, shaped forces patterns, with asymmetric opposite directions. The transmission between the opposite forces is very fast, and actually has a hammer's strike behavior.

For simplicity and consistency, the descriptions below states that the piston moves, while the cylinder is static. It is possible that the piston will be static, and the cylinder will move. In reality, most of the time, both the piston and the cylinder move. The significant point is that there is relative movement between the cylinder and the piston. The coordinating system in which the piston and the cylinder movements are defined is not important.

It should be clear that the terms “piston” and “cylinder” have to be understood in a metaphoric way. The “cylinder” may be a real cylinder as common in the hydraulic and pneumatic practice, but it may be any body which includes and guides the “piston”. The “piston” may be partly or completely inside the “cylinder”. The “piston” may be a real piston as common in the hydraulic and pneumatic practice, but it may be any body which is included and guided by the “cylinder”. The “cylinder” may partly or completely contain the “piston”.

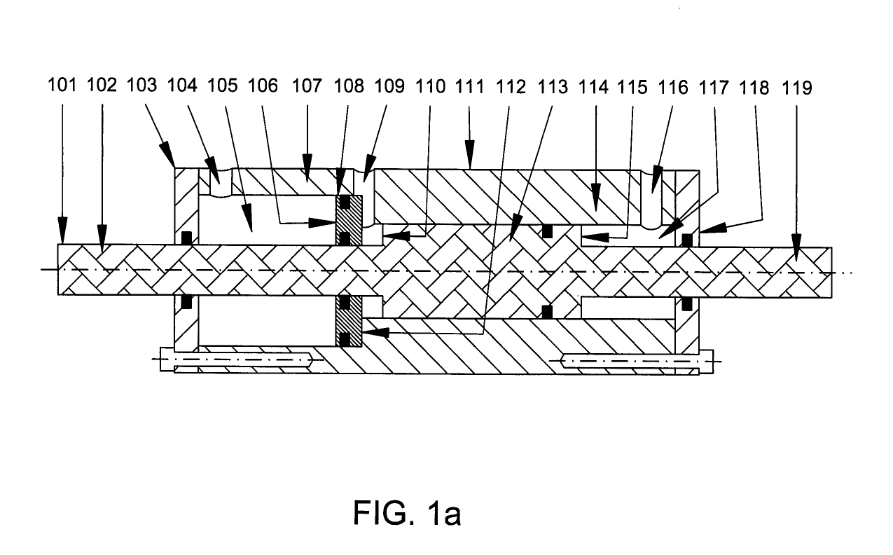

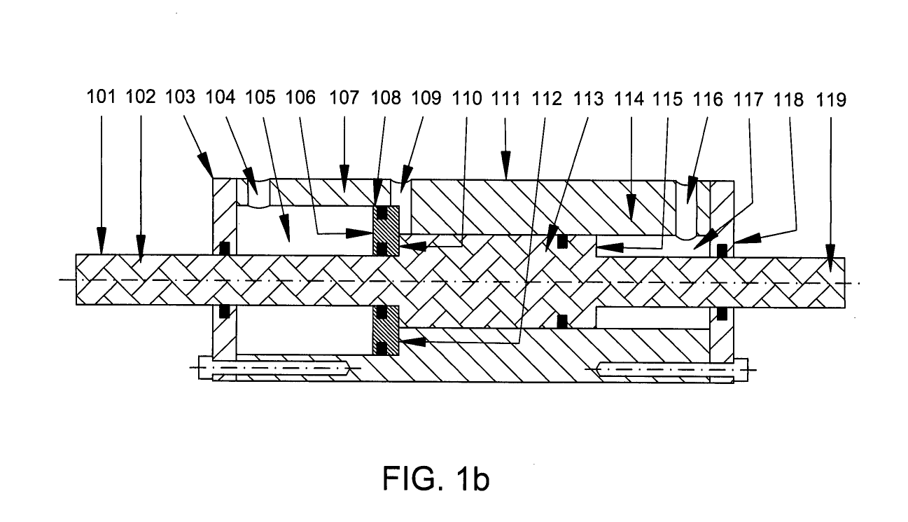

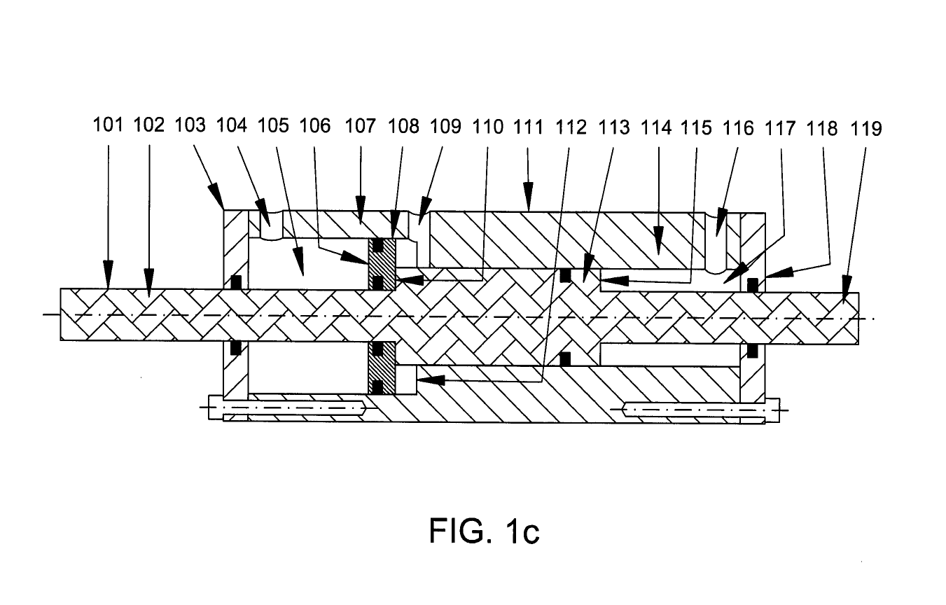

Reference is made to FIG. 1a, FIG. 1b, and FIG. 1c.

FIG. 1a, FIG. 1b, and FIG. 1c show cross-sections through a rebound-effector. A piston 101 moves inside a cylinder 111. A right chamber 117, which is composed of the cylinder 111, the piston 101, and a right cover 118, is connected to pressurized fluid and/or compressed gas, through a right port 116. A left chamber 105, which is composed of the cylinder 111, the piston 101, a Force-Barrier 108, and a left cover 103, is connected to pressurized fluid and/or compressed gas, through a left port 104. The pressurized fluid and/or compressed gas sources are not shown. A low pressure port 109 is connected to low pressurized fluid and/or to low compressed gas, is vacuumed, or is vented to the air. The source of the low pressure port 109 for low pressurized fluid and/or for low compressed gas is not shown. The inner diameter of a cylinder left side 107, left to the low pressure port 109, is bigger than the inner diameter of a cylinder right side 114, right to the low pressure port 109. The connection in between the two inner diameters of cylinder 111 is a step 112. The piston 101 has three parts. The diameter of a center part 113 is bigger than the diameter of a left side part 102, and of a right side part 119. The connection in between the diameter of the left side part 102 of the piston 101, and the center part 113 of the piston 101 is a piston left step 110. The connection in between the diameter of the right side part 119 of the piston 101, and the center part 113 of the piston 101 is a piston right step 115.

FIG. 1b shows the rebound-effector in the switching, or resting, position. The Force-Barrier 108 lies on the cylinder step 112, while the piston left step 110 lies on the Force-Barrier 108. As the area of the piston right step 115 times the pressure in the right chamber 117 is lower or smaller than an effective area 106 of the Force-Barrier 108 times the pressure in the left chamber 105, the piston 101 lies on the Force-Barrier 108, while the Force-Barrier 108 lies on the cylinder 111. The pressure in the low pressure port 109 is low, and has no real influence. If the piston 101 has no kinetic energy, it will statically stay, or rest, in this position.

FIG. 1a shows the rebound-effector having the piston 101 to the right of the rest position as shown by FIG. 1b. The piston 101 is loaded to the left by a force equal to the piston right step 115 area times the pressure in the right chamber 117. The Force-Barrier 108 lies on the cylinder step 112, and does not load the piston 101. The pressure in the low pressure port 109 is low, and practically has no influence. The effective force on the piston 101 is to the left by the magnitude of the piston right step 115 area times the pressure in the right chamber 117.

FIG. 1c shows the rebound-effector having the piston 101 to the left of the rest position as shown by FIG. 1b. The piston 101 is loaded to the left by a force equal to the piston right step 115 area times the pressure in the right chamber 117, and to the right by a force equal to the effective area 106 of the Force Barrier 108 times the pressure in left chamber 105. As the force to the right is stronger than the force to the left, the resultant is a force to the right.

Each time the piston 101 crosses the rest position as shown by FIG. 1b, the effective force reverses direction. The force switches from leftward to rightward if the piston 101 moves to the left, and from rightward to leftward if the piston 101 moves to the right. This is the reason why the rest position is called switching position or switching point as well.

The force reversing, as described above, is very fast—actually by the speed of voice. There is no need for any kind of control. The Force-Barrier 108 has completely passive behavior. The force reversing will always be done at the same point relative to the cylinder 111, whether the rebound-effector will be horizontal, vertical, or angled to the horizon. The switching point is not effected by gravity, by the velocity of the piston 101, by the acceleration of the piston 101, by the pressure in the left chamber 105, by the pressure in the right chamber 117, nor by situation in which the piston 101 is stable and the cylinder 111 moves. As the Force-Barrier 108 is completely passive, no external energy for control is needed.

The force reversing is done by mechanically removing or loading a force, or forces. This process does not include draining of high pressurized fluid and/or high compressed gas from a high pressure chamber to a low pressure chamber. It means that the left chamber 105 as well as the right chamber 117 may be part of a completely closed system, or systems. No drain nor charge of pressurized fluid and/or compressed gas is needed.

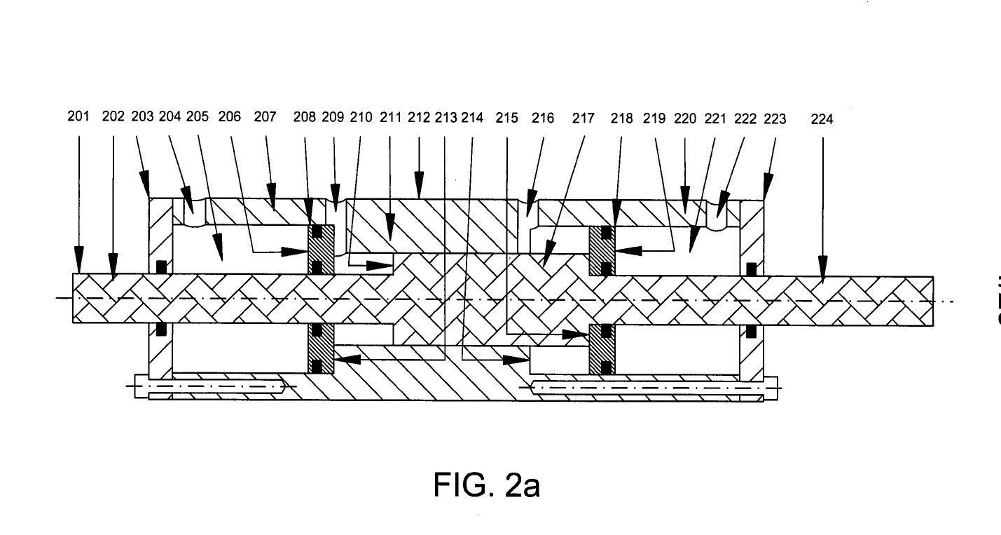

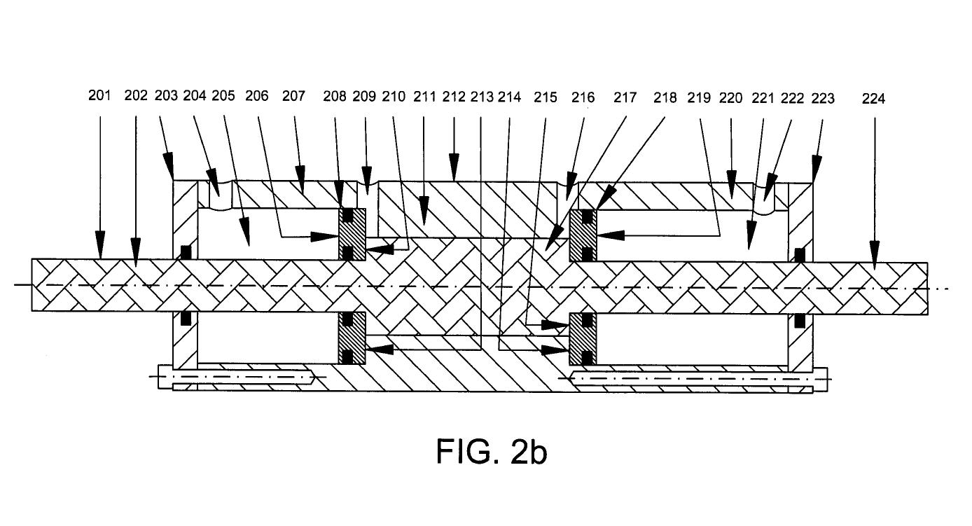

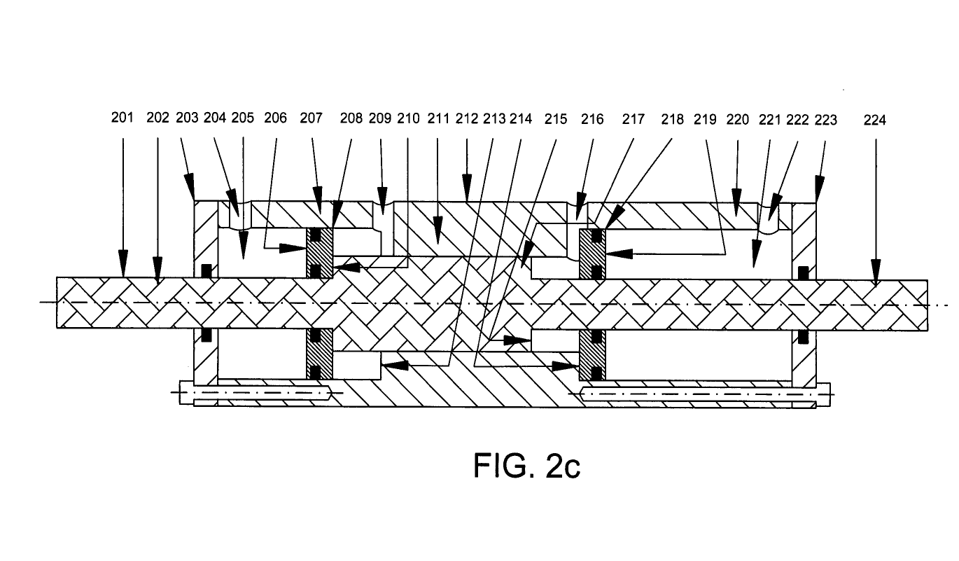

Reference is made to FIG. 2a, FIG. 2b, and FIG. 2c.

FIG. 2a, FIG. 2b, and FIG. 2c show cross-sections through a rebound-effector having two Force-Barriers. A cylinder 212 has three internal diameters. A cylinder central part 211, which is limited by a cylinder left step 213 and a cylinder right step 214, has a smaller diameter than a cylinder left part 207 and a cylinder right part 220. A piston 201 has three diameters. A piston central part 217, which is limited by a piston left step 210 and a piston right step 215, has the biggest diameter than a piston left part 202 and a piston right part 224. A left chamber 205 is composed of the cylinder 212, a left cover 203, the piston 201, and a left Force-Barrier 208. The left chamber 205 is connected to pressurized fluid and/or compressed gas, through a left port 204. A Right chamber 221 is composed of the cylinder 212, a right cover 223, the piston 201, and a right Force-Barrier 218. The right chamber 221 is connected to pressurized fluid and/or compressed gas, through a right port 222. The pressurized fluid and/or compressed gas sources are not shown. The piston central part 217 and the cylinder central part 211 have the same length. A left vent chamber 209 as well as a right vent chamber 216 are connected to low pressurized fluid and/or low compressed gas, are vacuumed, or are vented to the air.

FIG. 2b shows the rebound-effector in the rest, or the switching, position. The right Force-Barrier 218 lies on the cylinder right step 214, and the left Force-Barrier 208 lies on the cylinder left step 213. This is the static, resting, balanced position, as well as the switching position in case the piston 201 is in motion.

FIG. 2a shows the rebound-effector when the piston 201 is to the right of the rest position as shown by FIG. 2b. In this position, the left Force-Barrier 208 lies on the cylinder left step 213, and the right Force-Barrier 218 lies on the piston right step 215. There is a leftward force on the piston 201 with the magnitude of an effective area 219 of the right Force Barrier 218 times the pressure in the right chamber 221. The pressures in the left vent chamber 209 and in the right vent chamber 216 are low and have no effect on the piston 201.

FIG. 2c shows the rebound effector when the piston 201 is to the left of the rest position as shown by FIG. 2b. In this position, the right Force-Barrier 218 lies on the cylinder right step 214, and the left Force-Barrier 208 lies on the piston left step 210. There is a rightward force on the piston 201 with the magnitude of an effective area 206 of the left Force-Barrier 208 times the pressure in the left chamber 205. The pressures in the left vent chamber 209 and in the right vent chamber 216 are low, and have no effect on the piston 201.

Each time the piston 201 crosses the rest position as shown by FIG. 2b, the effective force reverses direction. The force switches from leftward to rightward—if the piston 201 moves to the left, and from rightward to leftward—if the piston 201 moves to the right. This is the reason why the rest position is called switching position or switching point as well.

The force reversing, as described above, is very fast—actually by the speed of voice. There is no need for any kind of control. The left Force-Barrier 208 and the right Force-Barrier 218 have completely passive behavior. The force reversing will always be done at the same point relative to the cylinder 212, whether the rebound-effector will be horizontal, vertical, or angled to the horizon. The switching point is not effected by gravity, by the velocity of the piston 201, by the acceleration of the piston 201, by the pressure in the left chamber 205, by the pressure in the right chamber 221, nor by a situation in which the piston 201 is stable while the cylinder 212 moves. As the left Force-Barrier 208 and the right Force-Barrier 218 are completely passive, no external energy for control is needed.

The force reversing is done by mechanically removing or loading a force, or forces. This process does not include draining high pressurized fluid and/or high compressed gas from a high pressure chamber to a low pressure chamber. It means that the left chamber 205 as well as the right chamber 221 may be parts of a completely closed system, or systems. No drain or charge of pressurized fluid and/or compressed gas is needed.

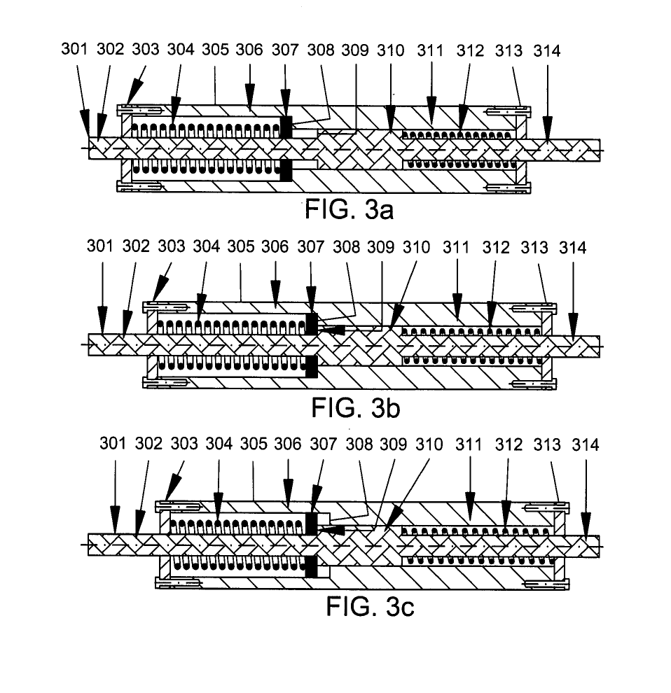

Reference is made to FIG. 3a, FIG. 3b, and FIG. 3c.

FIG. 3a, FIG. 3b, and FIG. 3c show cross-sections through a rebound-effector which is energized by two springs. A cylinder 305 has a bigger diameter in a cylinder left side 306 than in a cylinder right side 311. A piston 301 has bigger diameter in a piston middle side 310 than in a piston left side 302 and in a piston right side 314. A right spring 312 pushes the piston 301 to the left, against a right cover 313. A left spring 304 pushes a Force-Barrier 307 to the right against a left cover 303. The Force-Barrier 307 slides along the cylinder left side 306, and along the piston left side 302. The Force-Barrier 307 lies on the cylinder 305 when it comes to contact with a cylinder step 308 in between the two diameters of the cylinder 305. The Force-Barrier 307 lies on the piston 301 when it comes to contact with a piston left step 309 in between the piston left part 302 and the piston middle part 310.

FIG. 3b shows the rebound-effector in the rest position, or the switching point. The right spring 312 pushes the piston 301 to the left, but the left spring 304, which is stronger than the right spring 312, pushes the Force-Barrier 307 and the piston 301 to the right. The Force-Barrier 307 cannot move any more to the right as it lies on the cylinder step 308. This is the static, resting, balanced position, as well as the switching position if the piston 301 is in motion.

FIG. 3a shows the rebound-effector when the piston 301 is to the right of the rest position as shown by FIG. 3b. The right spring 312 pushes the piston 301 to the left against the right cover 313. The left spring 304 pushes the Force-Barrier 307 to the right, against the left cover 303, but the Force-Barrier 307 lies on the cylinder step 308. The resultant force on the piston 301 is to the left.

FIG. 3c shows the rebound-effector when the piston 301 is to the left of the rest position as shown by FIG. 3b. The right spring 312 pushes the piston 301 to the left against the right cover 313. The left spring 304 pushes the Force-Barrier 307 to the right, against the left cover 303. The Force-Barrier 307 lies on the piston left step 309, and pushes the piston 301 to the right. As the left spring 304 is stronger than the right spring 312, the resultant force on the piston 301 is to the right.

Each time the piston 301 crosses the rest position as shown by FIG. 3b, the effective force on the piston 301 reverses direction. The force switches from leftward to rightward—if the piston 301 moves to the left, and from rightward to leftward —if the piston 301 moves to the right. This is the reason why the rest position is called switching position or switching point as well.

The force reversing, as described above, is very fast—actually by to the speed of voice. There is no need for any kind of control—the Force-Barrier 307 has completely passive behavior. The force reversing will always be done at the same point relative to the cylinder 305, whether the rebound-effector will be horizontal, vertical, or angled to the horizon. The switching point is not effected by gravity, by the velocity of the piston 301, by the acceleration of the piston 301, by the strength of the left spring 304, by the strength of the right spring 312, as long as the left spring 304 is stronger than the right spring 312, nor by a situation in which the piston 301 is stable while the cylinder 305 moves. As the Force-Barrier 307 is completely passive, no external energy for control is needed.

The force reversing is done by mechanically removing or loading a force, or forces. This process does not include draining high pressurized fluid and/or high compressed gas from a high pressure chamber to a low pressure chamber. It means that the described rebound-effector includes a complete energy converter, with no drain, nor charge, of any pressurized fluid and/or compressed gas.

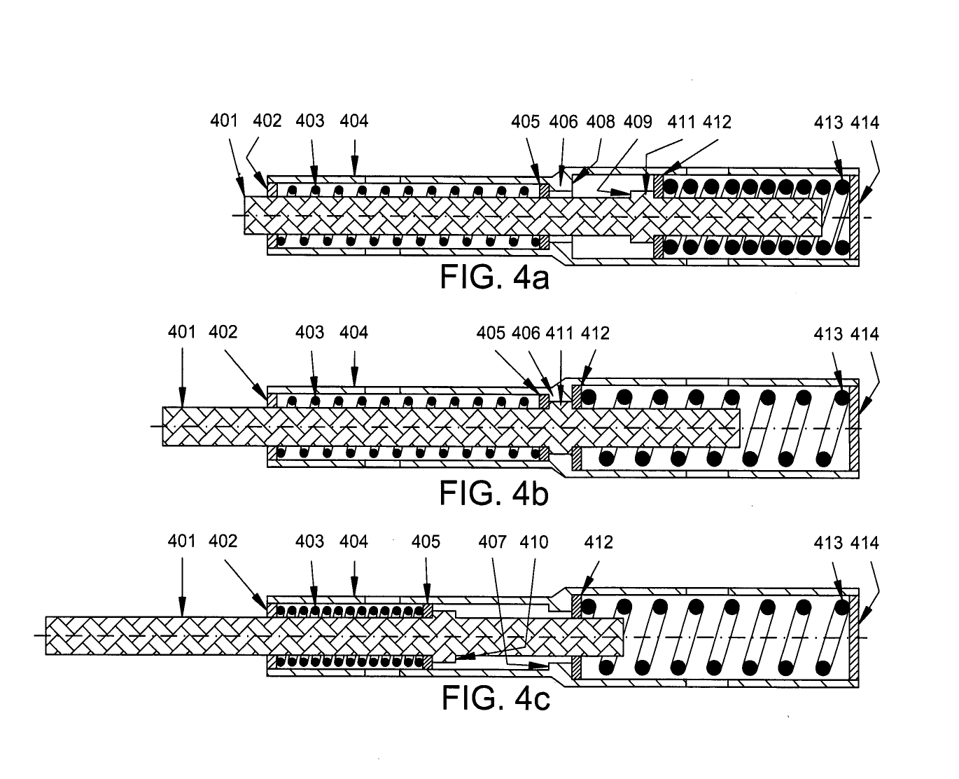

Reference is made to FIG. 4a, FIG. 4b, and FIG. 4c.

FIG. 4a, FIG. 4b, and FIG. 4c show cross-sections through a rebound-effector which is energized by two springs, and has two Force-Barriers. A cylinder 404 has three internal diameters. A cylinder central part 406, which is limited by a cylinder left step 407 and a cylinder right step 408, has the smallest diameter than the right and the left parts. A piston 401 has three diameters. A piston central part 411, which is limited by a piston left step 409 and a piston right step 410, has the bigger diameter than the left and the right parts. A left spring 403 pushes a left Force-Barrier 405 to the right, against a left cover 402. A right spring 413 pushes a right Force-Barrier 412 to the left, against a right cover 414. The piston central part 411 and the cylinder central part 406 have the same length. The chamber created by the inner part of the cylinder 404, the piston 401, the left cover 402, and the right cover 414 is vented, vacuumed, sealed, or connected to a pressurized gas chamber.

FIG. 4b shows the rebound-effector in rest position, or in switching position. The left Force-Barrier 405 lies on the cylinder left step 407, and the right Force-Barrier 412 lies on the cylinder right step 408. This is the static, resting, balanced position, as well as the switching position in case the piston 401 is in motion.

FIG. 4a shows the rebound-effector when the piston 401 is to the right of the rest position as shown by FIG. 4b. In this position, the left Force-Barrier 405 lies on the left cylinder step 407, and the right Force-Barrier 412 lies on the piston right step 410. There is leftward force on the piston 401.

FIG. 4c shows the rebound-effector when the piston 401 is to the left of the rest position as shown by FIG. 4b. In this position, the right Force-Barrier 412 lies on the right cylinder step 408, and the left Force-Barrier 405 lies on the piston left step 409. There is rightward force on the piston 401.

Each time the piston 401 crosses the rest position as shown by FIG. 4b, the effective force reverses direction. The force switches from leftward to rightward—if the piston 401 moves to the left, and from rightward to leftward—if the piston 401 moves to the right. This is the reason why the rest position is called switching position or switching point as well.

The force reversing, as described above, is very fast, actually by to the speed of voice. There is no need for any kind of control. The left Force-Barrier 405 and the right Force-Barrier 412 have completely passive behavior. The force reversing will always be done at the same point relative to the cylinder 404, whether the rebound-effector will be horizontal, vertical, or angled to the horizon. The switching point is not effected by gravity, by the velocity of the piston 401, by the acceleration of the piston 401, by the left spring 403, by the right spring 413, nor by situation in which the piston 401 is stable while the cylinder 404 moves. As the left Force-Barrier 405 and the right Force-Barrier 412 are completely passive, no external energy for control is needed.

The force reversing is done by mechanically removing or loading a force, or forces. This means that the described rebound-effector is a completely closed energy converter.

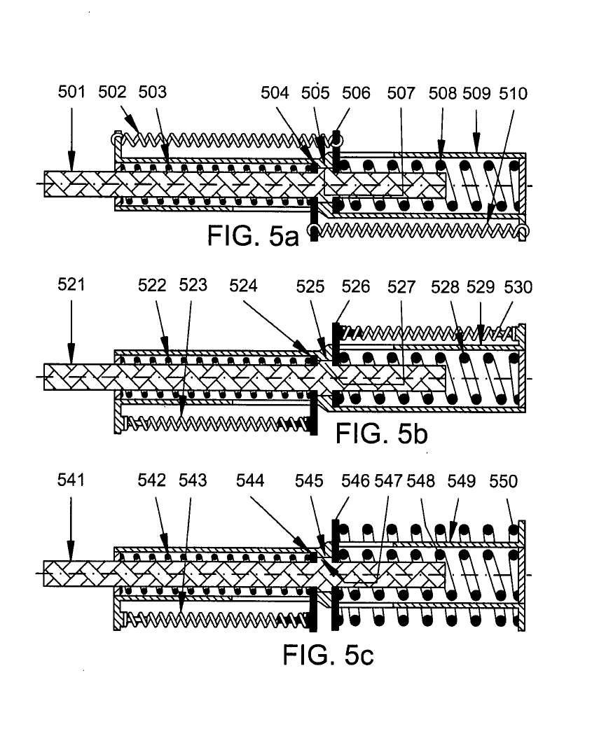

Reference is made to FIG. 5a, FIG. 5b, and FIG. 5c.

FIG. 5a shows a cross-section through a rebound-effector having two Force-Barriers, and four springs. A piston 501 has a relatively wide piston middle part 507, and a cylinder 509 has a relatively narrow cylinder middle part 505. A left Force-barrier 504 is effected by a left compressive spring 503 and by a right tension spring 510. A right Force-Barrier 506 is effected by a right compressive spring 508 and by a left tension spring 502.

The left tension spring 502 and the right tension spring 510 are outside the cylinder 509. The left tension spring 502 and/or the right tension spring 510 may be one single spring, or a few springs, identical springs, or different springs.

The functionality of the left Force-Barrier 504 and the right Force-Barrier 506 is the same as described above.

FIG. 5b shows a cross-section through a rebound-effector having two Force-Barriers and four springs. A piston 521 has a relatively wide piston middle part 527, and a cylinder 529 has a relatively narrow cylinder middle part 525. A left Force-barrier 524 is effected by a left compressive spring 522 and by a left external compression spring 523. A right Force-Barrier 526 is effected by a right compressive spring 528 and by a right external compression spring 530.

The left external compression spring 523 and the right external compression spring 530 are outside the cylinder 529. The left external compression spring 523 and/or the right external compression spring 530 may be one single spring, or few springs, identical springs, or different springs.

The functionality of the left Force-Barrier 524 and the right Force-Barrier 526 is the same as described above.

FIG. 5c shows a cross-section through a rebound-effector having two Force-Barriers and four springs. A piston 541 has a relatively wide piston middle part 547, and a cylinder 549 has a relatively narrow cylinder middle part 545. A left Force-barrier 544 is effected by a left compression spring 542 and by a left external compression spring 543. A right Force-Barrier 546 is effected by a right compression spring 548 and by a right external compression spring 550.

The left external compression spring 543 and the right external compression spring 550 are outside the cylinder 549. The left external compression spring 543 and/or the right external compression spring 550 may be one single spring, or few springs, identical springs, or different springs.

The functionality of the left Force-Barrier 544 and the right Force-Barrier 546 is the same as described above.

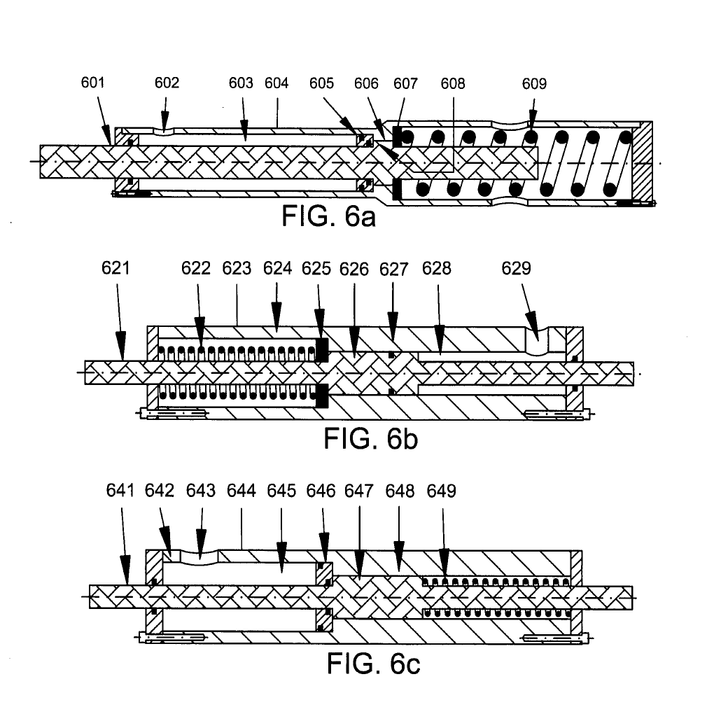

Reference is made to FIG. 6a, FIG. 6b, and FIG. 6c.

FIG. 6a shows a cross-section through a rebound-effector having two Force-Barriers, and being energized by pressurized liquid and/or compressed gas on the left side, and a spring on the right side. A piston 601 has a relatively wide piston middle part 608, and a cylinder 604 has a relatively narrow cylinder middle part 606. A left Force-barrier 605 is pushed to the right by the pressure in a left chamber 603. The left chamber 603 is full with pressurized liquid and/or compressed gas, which is delivered from a port 602. The pressurized liquid and/or compressed gas supply is not shown. A right Force-Barrier 607 is pushed to the left by a right spring 609.

FIG. 6b shows a cross-section through a rebound-effector having one Force-Barrier, and being energized by pressurized liquid and/or compressed gas on the right side, and a spring on the left side. A piston 621 has a relatively wide piston middle part 626. A cylinder 623 has a relatively narrow cylinder right part 627 and a relatively wide cylinder left part 624. A Force-Barrier 625 is pushed to the right by a spring 622. A right chamber 628 is full with pressurized liquid and/or compressed gas, which is delivered from a port 629. The pressurized liquid and/or compressed gas supply is not shown. The piston 621 is pushed to the left by the pressure in the right chamber 628.

FIG. 6c shows a cross-section through a rebound-effector having one Force-Barrier, and being energized by pressurized liquid and/or compressed gas on the left side, and a spring on the right side. A piston 641 has a relatively wide piston middle part 647. A cylinder 644 has a relatively narrow cylinder right part 648 and a relatively wide cylinder left part 642. The piston 641 is pushed to the left by a spring 649. A left chamber 645 is full with pressurized liquid and/or compressed gas, which is delivered from a port 643. The pressurized liquid and/or compressed gas supply is not shown. A Force-Barrier 646 is pushed to the right by the pressure in the left chamber 645.

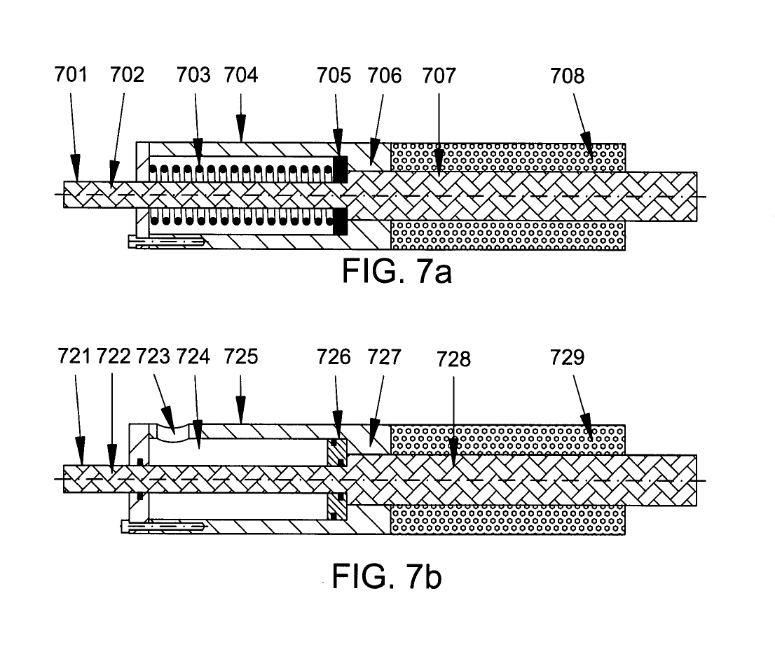

Reference is made to FIG. 7a and FIG. 7b.

FIG. 7a shows a cross-section through a rebound-effector having one Force-Barrier, and being energized by spring on the left side, and by an electro magnet on the right side. A piston 701 has a relatively wide piston right part 707 and a relatively narrow piston left part 702. A cylinder 704 has a relatively narrow cylinder right part 706. A Force-Barrier 705 is pushed to the right by a spring 703. A coil 708, together with the piston right part 707 forms the electro magnet, which pushes the piston 701 to the left. The electric supply to the coil 708 is not shown.

FIG. 7b shows a cross-section through a rebound-effector having one Force-Barrier, and being energized by pressurized liquid and/or compressed gas on the left side, and an electro magnet on the right side. A piston 721 has a relatively wide piston right part 728 and a relatively narrow piston left part 722. A cylinder 725 has a relatively narrow cylinder right part 727. A Force-Barrier 726 is pushed to the right by the pressure in a chamber 724. The chamber 724 is full with pressurized liquid and/or compressed gas, which is supplied through a port 723. The pressurized liquid and/or compressed gas supply is not shown. A coil 729, together with the piston right part 728 forms the electro magnet, which pushes the piston 721 to the left. The electric supply to the coil 729 is not shown.

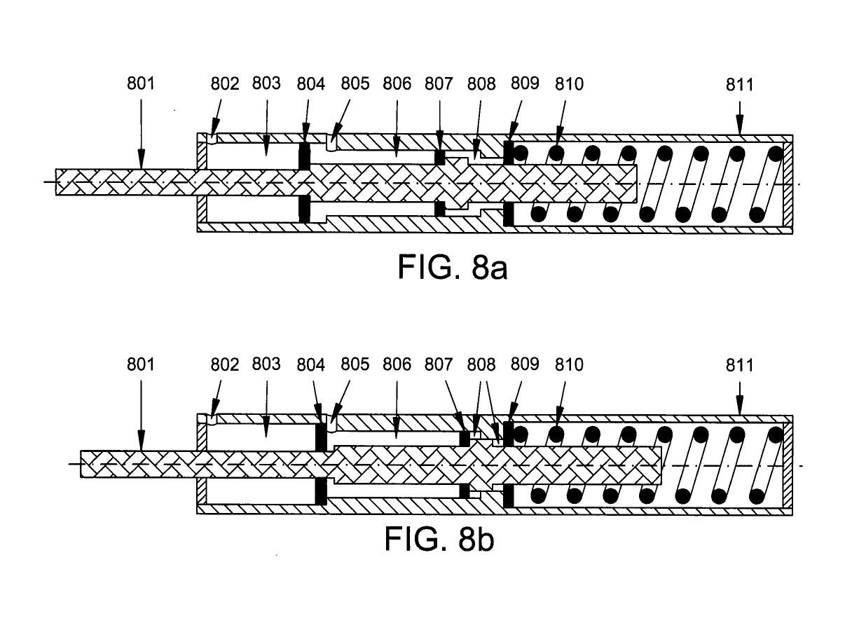

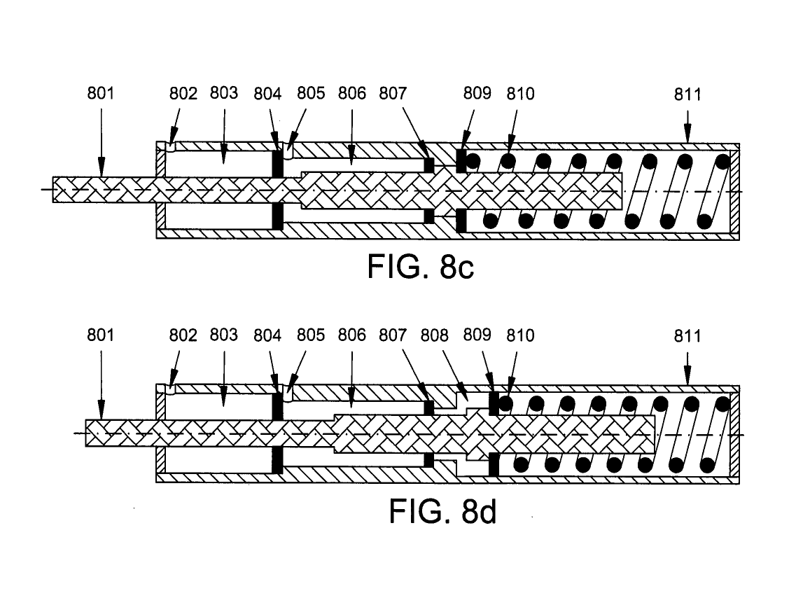

Reference is made to FIG. 8a, FIG. 8b, FIG. 8c, and FIG. 8d.

There may be more than two Force-Barriers in one device, influencing the same piston. There are a lot of potential combinations—the number of Force-Barriers pushing the piston to the left, the number of Force-Barriers pushing the piston to the right, and the energy source for each of the Force-Barriers.

FIG. 8a, FIG. 8b, FIG. 8c, and FIG. 8d show a rebound-effector having three Force-Barriers, namely a First-Force-Barrier 804, a second-Force-Barrier 807, and a third-Force-Barrier 809. This arrangement enables three force sources to be applied on a piston 801—a left chamber 803 pressure, a right chamber 806 pressure, and a spring 810. A cylinder 811 has four internal diameters. The piston 801 has four external diameters. The left chamber 803 is full with pressurized liquid and/or compressed gas, which is supplied through a port 802, and pushes the first Force-Barrier 804 to the right. The right chamber 806 is full with pressurized liquid and/or compressed gas, which is supplied through a port 805, and pushes the second Force-Barrier 807 to the right. The pressurized liquid and/or compressed gas sources for the left chamber 803 and for the right chamber 806 are not shown. A vent chamber 808 is vented to the air, vacuumed, or connected to a low pressure source, and has no influence on the piston 801. A spring 810 pushes the third Force-Barrier 809 to the left.

In the position as shown by FIG. 8a, the piston 801 is influenced by the pressure in the left chamber 803 and the pressure in the right chamber 806.

In the position as shown by FIG. 8b, the piston 801 is influenced by the pressure in the right chamber 806.

In the position as shown by FIG. 8d, the piston 801 is influenced by the spring 810.

FIG. 8c shows the rest, static position, or switching point in case the piston 801 is in motion.

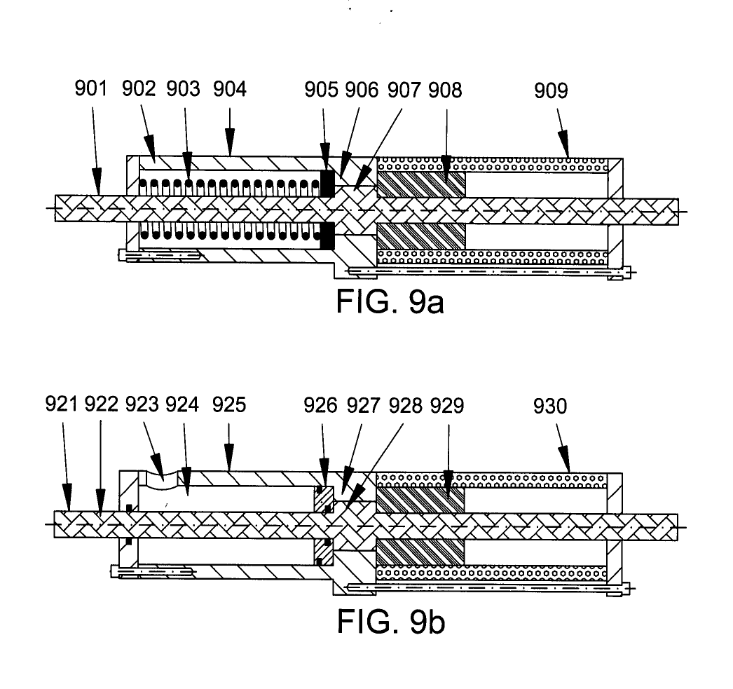

Reference is made to FIG. 9a and FIG. 9b.

FIG. 9a shows a cross-section through a rebound-effector having two Force-Barriers, and being energized by a spring on the left side, and a moving magnet motor on the right side. A piston 901 has a relatively wide piston middle part 907. A cylinder 904 has a relatively narrow cylinder middle part 906 and a relatively wide cylinder left part 902. A left Force-barrier 905 is pushed to the right by a spring 903. A magnet Force-Barrier 908, together with a coil 909, forms a moving magnet motor, which pushes the piston 901 to the left. The electric supply to the coil 909 is not shown.

FIG. 9b shows a cross-section through a rebound-effector having two Force-Barriers, and being energized by pressurized liquid and/or compressed gas on the left side, and a moving magnet motor on the right side. A piston 921 has a relatively wide piston middle part 928, and a relatively narrow piston left part 922. A cylinder 925 has a relatively narrow cylinder middle part 927. A left Force-barrier 926 is pushed to the right by the pressure in a chamber 924. The chamber 924 is full with pressurized liquid and/or compressed gas, which is delivered through a port 923. A magnet Force-Barrier 929, together with a coil 930, forms a moving magnet motor, which pushes the piston 921 to the left. The electric supply to the coil 930 is not shown. The pressurized liquid and/or compressed gas source for the chamber 924 is not shown either.

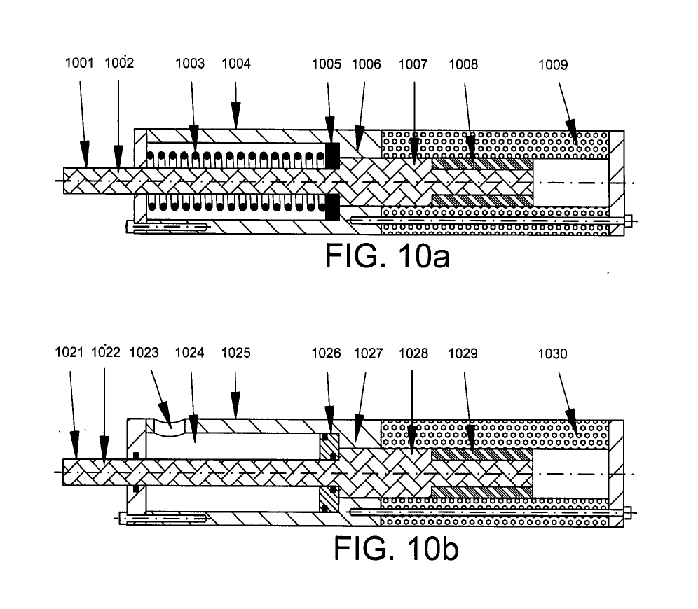

Reference is made to FIG. 10a and FIG. 10b.

FIG. 10a shows a cross-section through a rebound-effector having one Force-Barrier, and being energized by a spring on the left side, and by a moving magnet motor on the right side. A piston 1001 has a relatively wide piston right part 1007 and a relatively narrow piston left part 1002. A cylinder 1004 has a relatively narrow cylinder right part 1006. A Force-Barrier 1005 is pushed to the right by a spring 1003. A magnet 1008 is integrated with the piston 1001, and together with a coil 1009, forms a moving magnet motor, which pushes the piston 1001 to the left. The electric supply to the coil 1009 is not shown.

FIG. 10b shows a cross-section through a rebound-effector having one Force-Barrier, and being energized by pressurized liquid and/or compressed gas on the left side, and a moving magnet motor on the right side. A piston 1021 has a relatively wide piston right part 1028 and a relatively narrow piston left part 1022. A cylinder 1025 has a relatively narrow cylinder right part 1027. A Force-Barrier 1026 is pushed to the right by the pressure in a chamber 1024. The chamber 1024 is full with pressurized liquid and/or compressed gas, which is delivered through a port 1023. A magnet 1029 is integrated with the piston 1021, and together with a coil 1030, forms the moving magnet motor, which pushes the piston 1021 to the left. The electric supply to the coil 1030 is not shown. The pressurized liquid and/or compressed gas source for the chamber 1024 is not shown either.

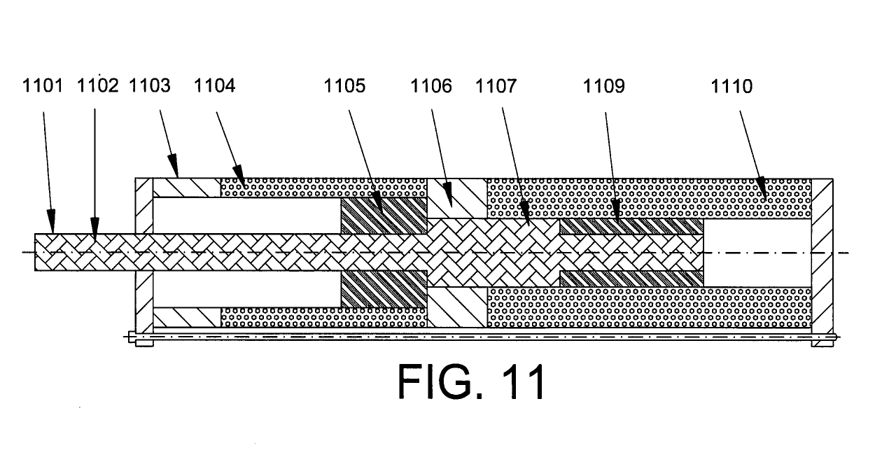

Reference is made to FIG. 11.

FIG. 11 shows a cross-section through a rebound-effector having one Force-barrier, and being driven to the left and to the right by moving magnet motors. A piston 1101 has a relatively wide piston right part 1107 and a relatively narrow piston left part 1102. A cylinder 1103 has a relatively narrow cylinder right part 1106. A magnet Force-Barrier 1105, together with a left coil 1104, forms a left moving magnet motor that pushes the piston 1101 to the right. A magnet 1109 is integrated with the piston 1101, and together with a right coil 1110 forms a right moving magnet motor, which pushes the piston 1101 to the left. The electric supplies to the left coil 1104 and to the right coil 1110 are not shown.

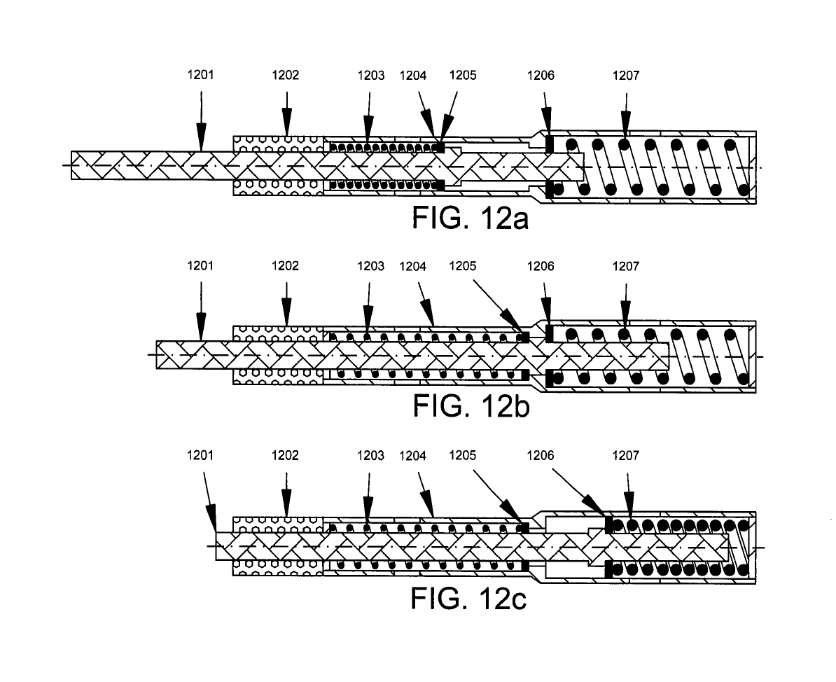

Reference is made to FIG. 12a, FIG. 12b, and FIG. 12c.

FIG. 12a, FIG. 12b, and FIG. 12c show cross-sections through a rebound-effector having two Force-Barriers, energized by two springs, and having an electro magnet. A left Force-Barrier 1205 is pushed to the right by a left spring 1203. A right Force-Barrier 1206 is pushed to the left by a right spring 1207. A coil 1202, which is attached to the left side of a cylinder 1204, together with a piston 1201, forms an electro magnet. The electric supply for the coil 1202 is not shown. Once the wires of the coil 1202 are open, the electro magnet idles, and has no influence on the behavior of the rebound-effector. Energizing the electro magnet so the force it creates is to the same direction as the movement of the piston 1201 adds energy to the piston 1201. Energizing the electro magnet so the force it creates is to the opposite direction of the movement of the piston 1201 reduces the energy of the piston 1201.

FIG. 12a shows the rebound-effector while the piston 1201 is left to the rest position, or switching point. FIG. 12b shows the rebound-effector while the piston 1201 is at the rest position, or switching point. FIG. 12c shows the rebound-effector while the piston 1201 is right to the rest position, or switching point.

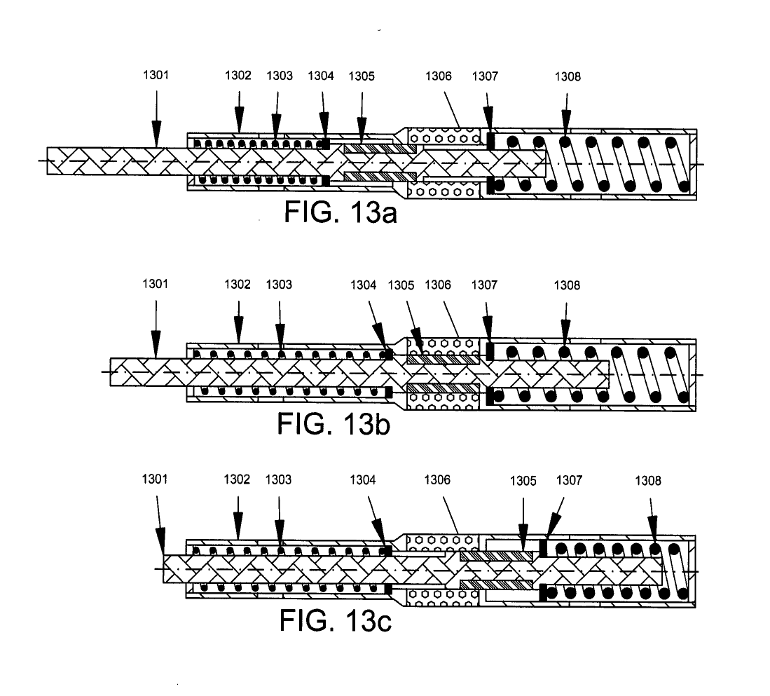

Reference is made to FIG. 13a, FIG. 13b, and FIG. 13c.

FIG. 13a, FIG. 13b, and FIG. 13c show cross-sections through a rebound-effector having two Force-Barriers, energized by two springs, and having a moving magnet motor. A left Force-Barrier 1304 is pushed to the right by a left spring 1303. A right Force-Barrier 1307 is pushed to the left by a right spring 1308. A coil 1306, which is integrated to a cylinder 1302, together with a magnet 1305, which is integrated with a piston 1301, forms a moving magnet motor. The electric supply to the coil 1306 is not shown. Once the wires of the coil 1306 are open, the moving magnet motor idles, and has no influence on the behavior of the rebound-effector. Energizing the coil 1306 so the force it creates is to the same direction as the movement of the piston 1301 adds energy to piston 1301. Energizing the coil 1306 so the force it creates is to the opposite direction of the movement of the piston 1301 reduces the energy of the piston 1301.

FIG. 13a shows the rebound-effector while the piston 1301 is left to the rest position, or switching point. FIG. 13b shows the rebound-effector while the piston 1301 is at the rest position, or switching point. FIG. 13c shows the rebound-effector while the piston 1301 is right to the rest position, or switching point.

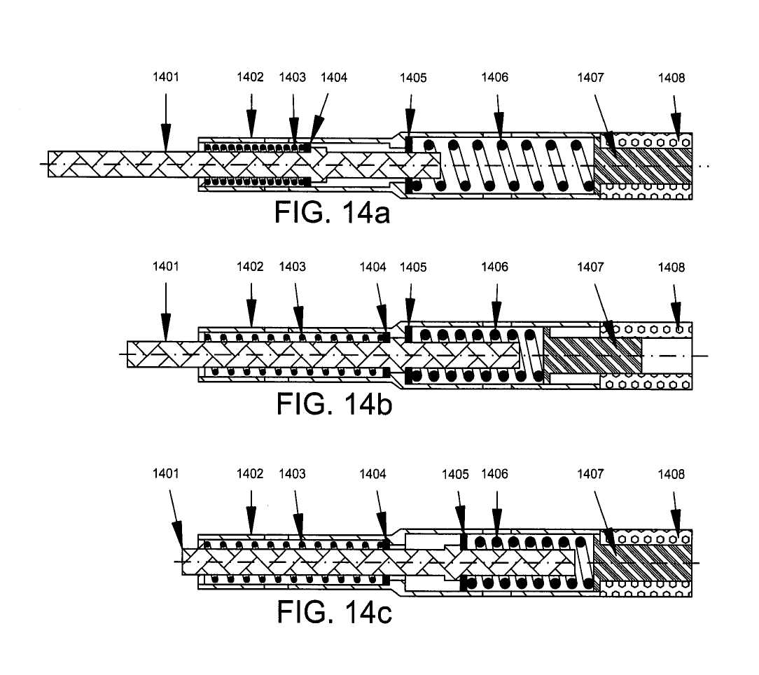

Reference is made to FIG. 14a, FIG. 14b, and FIG. 14c.

FIG. 14a, FIG. 14b, and FIG. 14c show cross-sections through a rebound-effector having two Force-Barriers, energized by two springs, and having a moving magnet motor. A left Force-Barrier 1404 is pushed to the right by a left spring 1403. A right Force-Barrier 1405 is pushed to the left by a right spring 1406. A moving magnet motor is attached to the right side of a cylinder 1402. A coil 1408 and a magnet 1407 compose the moving magnet motor. The coil 1408 is rigidly connected to the cylinder 1402, while the magnet 1407 moves. The electric supply to the coil 1408 is not shown. A piston 1401 has no direct contact with the magnet 1407. Once the wires of the coil 1408 are open, the moving magnet motor idles, and has no influence on the behavior of the rebound-effector. Energizing the coil 1408 so the force it creates is to the same direction as the movement of the piston 1401 adds energy to the piston 1401. Energizing the coil 1408 so the force it creates is to the opposite direction to the movement of the piston 1401 reduces the energy of the piston 1401. The moving magnet motor is effective just when the piston 1401 is right to the rest position, or switching point.

FIG. 14a shows the rebound-effector while the piston 1401 is left to the rest or switching point, and the magnet 1407 is in a most right position. FIG. 14b shows the rebound-effector while the piston 1401 is at the rest position, or switching point, and the magnet 1407 is at a most left position. FIG. 14c shows the rebound-effector while the piston 1401 is right to the rest position, or switching point, and the magnet 1407 is at a most right position.

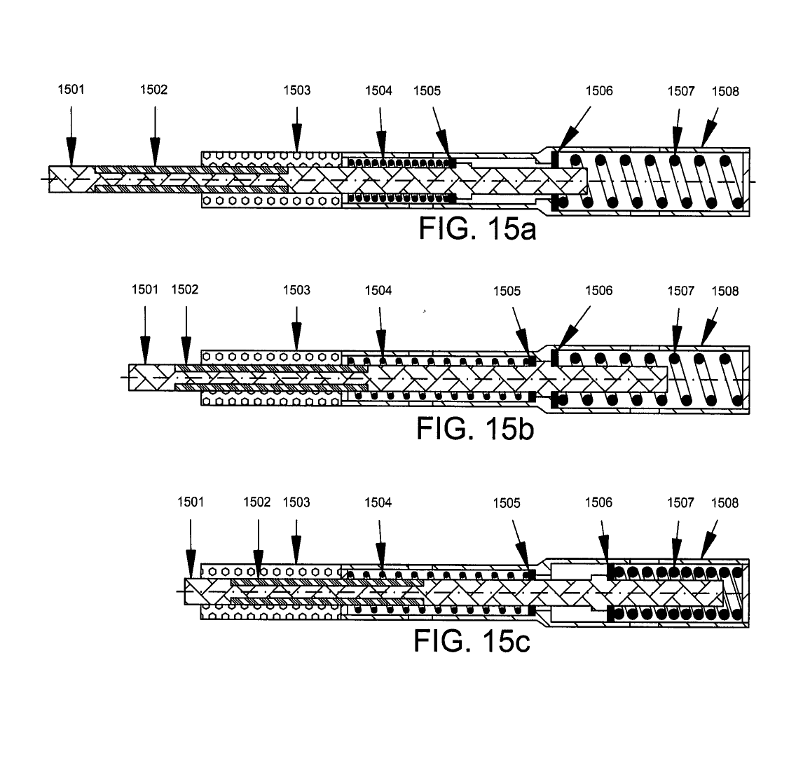

Reference is made to FIG. 15a, FIG. 15b, and FIG. 15c.

FIG. 15a, FIG. 15b, and FIG. 15c show cross-sections through a rebound-effector having two Force-Barriers, energized by two springs, and having a magnet which is integrated with the left part of a piston, and together with a coil creates a moving magnet motor. A left Force-Barrier 1505 is pushed to the right by a left spring 1504. A right Force-Barrier 1506 is pushed to the left by a right spring 1507. A coil 1503 which is attached to the left side of a cylinder 1508, together with a magnet 1502, which is integrated with a piston 1501, forms a moving magnet motor. The electric supply to the coil 1503 is not shown. Once the wires of the coil 1503 are open, the moving magnet motor idles, and has no influence on the behavior of the rebound-effector. Energizing the moving magnet motor so the force it creates is to the same direction as the movement of the piston 1501 adds energy to the piston 1501. Energizing the moving magnet motor so the force it creates is to the opposite direction to the movement of the piston 1501 reduces the energy of the piston 1501.

FIG. 15a shows the rebound-effector while the piston 1501 is left to the rest position, or switching point. FIG. 15b shows the rebound-effector while the piston 1501 is at the rest position, or switching point. FIG. 15c shows the rebound-effector while the piston 1501 is right to the rest position, or switching point.

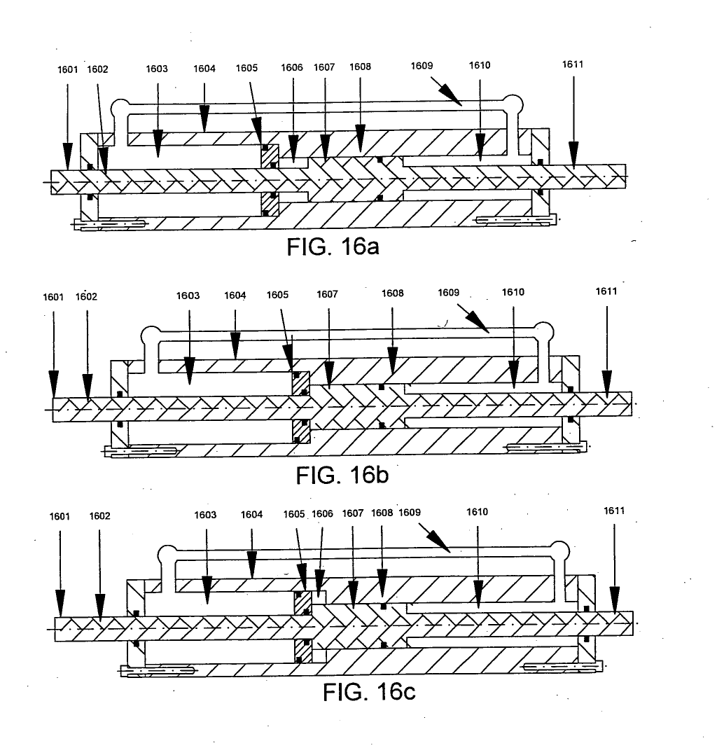

Reference is made to FIG. 16a, FIG. 16b, and FIG. 16c.

FIG. 16a, FIG. 16b, and FIG. 16c show cross-sections through a rebound-effector having one Force-Barrier, and being energized by compressed gas at both sides of a piston. A cylinder 1604 has a relatively narrow cylinder right part 1608. A piston 1601 has a relatively narrow piston left part 1602, a relatively narrow piston right part 1611, and relatively wide piston middle parts 1607. A Force-Barrier 1605 sets the length of a left chamber 1603, and may be laid on the cylinder 1604 as shown by FIG. 16a, or may be laid on the piston 1601, as shown by FIG. 16c. A vent chamber 1606 is vented to the air, connected to a low pressure chamber, or vacuumed. In any case, the vent chamber 1606 has no significant influence on the piston 1601. The venting of the chamber 1606 is not shown, nor the low pressure chamber option, nor the vacuum setting. The pressure in a right chamber 1610 pushes the piston 1601 to the left. The pressure in the left chamber 1603 pushes the Force-Barrier 1605 to the right. The left chamber 1603 and the right chamber 1610 are connected to each other by a tube 1609. When the piston 1601 is at the right side to the rest position, or switching point, as shown by FIG. 16a, the Force-Barrier 1605 lies on the cylinder 1604, and is influenced by the pressure in the right chamber 1610, resulting in a leftward force. When the piston 1601 is at the left side to the rest position, or switching point, as shown by FIG. 16C, the Force-Barrier 1605 lies on it, and is pushed to the left by the pressure in the right chamber 1610, and to the right by the pressure in the left chamber 1603. Although the pressure in the left chamber 1603 and in the right chamber 1610 is the same, the effective area of the Force-Barrier 1605 is bigger than the effective area of the piston 1601 at the right chamber 1610, and the resultant force is to the right. FIG. 16b shows the piston 1601 in the rest position, or switching point.

FIG. 16a, FIG. 16b, and FIG. 16c show a fully closed energy converted system. If the piston 1601 starts from the position as shown by FIG. 16a, it is loaded by the pressure in the right chamber 1610, and has a leftward force. This force accelerates the piston 1601 to the left, converting pneumatic energy of the compressed gas into kinetic energy of the piston 1601. Once the piston 1601 crosses the switching point to the left, as shown by FIG. 16b, the resultant force changes from a leftward to a rightward direction. The piston 1601 velocity is reduced by the compressed gas pressure in the left chamber 1603, converting the kinetic energy of the piston 1601 into the compressed gas pneumatic energy. Eventually, the piston 1601 will stop moving to the left and will start moving to the right, converting the compressed gas pneumatic energy into kinetic energy while accelerating to the right. Once the piston 1601 crosses the switching point to the right, as shown by FIG. 16b, the resultant force changes from a rightward to a leftward direction. The right movement kinetic energy of the piston 1601 is converted to the compressed gas pneumatic energy. Neglecting friction and non-efficiency, the piston 1601 will stop moving to the right at the some point where it started the cycle. The rebound-effector converted compressed gas pneumatic energy into mass kinetic energy, and vice versa. The energy conversion was done in a complete closed environment, and without any control.

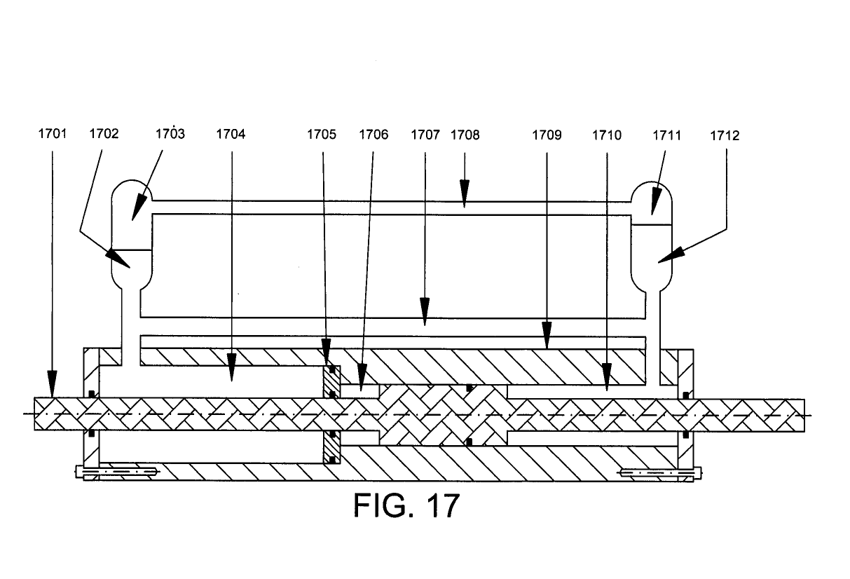

Reference is made to FIG. 17.

FIG. 17 shows a cross-section through a rebound-effector having one Force-barrier, and being energized by pressurized liquid. Among other things, a left chamber 1704 is limited by a cylinder 1709, a piston 1701, and a Force-Barrier 1705. Among other things, a right chamber 1710 is limited by the cylinder 1709, and the piston 1701. The left chamber 1704, the right chamber 1710, a low side left accumulator 1702, a low side right accumulator 1712, and a tube 1707 are connected each other, and full with pressurized liquid. A top side left accumulator 1703, a top side right accumulator 1711, and a tube 1708 are connected each other, and full with compressed gas. A vent chamber 1706 is vented to the air, vacuumed, or connected to a low pressure chamber—not shown. FIG. 17 shows the piston 1701 at a position right to the rest position, or switching point. In this position, the piston 1701 is influenced just by the pressure in the right chamber 1710, and the resultant force is to the left.

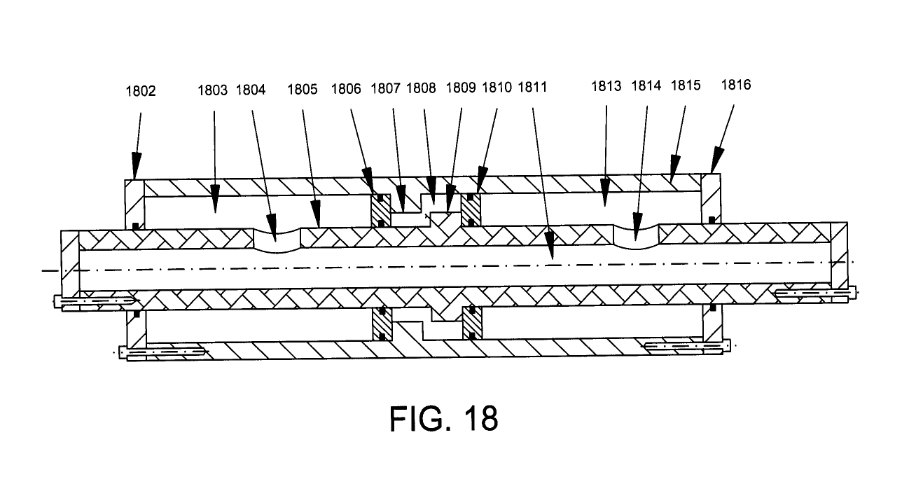

Reference is made to FIG. 18.

FIG. 18 shows a cross-section through a rebound-effector having two Force-Barriers, and being energized by compressed gas at both sides of the piston. A piston 1805 has a hollow inner part 1811, and a relatively wide piston middle part 1809. A cylinder 1815 has a relatively narrow cylinder middle part 1807. A left chamber 1803 is limited by a left cover 1802, the cylinder 1815, the piston 1805, and a left Force-Barrier 1806. A right chamber 1813 is limited by a right cover 1816, the cylinder 1815, the piston 1805, and a left Force-Barrier 1810. The left chamber 1803 is connected to the hollow inner part 1811 of the piston 1805, by a left port 1804. The right chamber 1813 is connected to the hollow inner part 1811 of the piston 1805, by a right port 1814. A vent chamber 1808 is vented to the air, connected to low pressure, or vacuumed—not shown. The position of the piston 1805, as shown by FIG. 18, is to the right of the rest position, or switching point. In this case, a force equal to the pressure in the right chamber 1813 times the effective area of the right Force-Barrier 1810 is applied on the piston 1805, with a leftward direction.

Reference is made to FIG. 19a, FIG. 19b, and FIG. 19c.

FIG. 19a, FIG. 19b, and FIG. 19c show a cross-section through a rebound-effector having one Force-Barrier, and being energized by pressured liquid at both sides of a piston. A piston 1901 has a relatively wide piston middle part 1908. A cylinder 1910 has a relatively narrow cylinder right part 1909. A left chamber 1905 is limited, among other things, by the cylinder 1910, the piston 1901, and a Force-Barrier 1906. The left chamber 1905 is connected to a lower part left accumulator 1903. A right chamber 1911 is limited, among other things, by the cylinder 1910 and the piston 1901. The right chamber 1911 is connected to a low part right accumulator 1912. The left chamber 1905, the low side left accumulator 1903, the right chamber 1911, and the low side right accumulator 1912 are full with pressurized liquid. An upper part left accumulator 1902 and an upper part right accumulator 1913 are full with compressed gas. A vent chamber 1907 is vented to the air, vacuumed, or connected to a low pressure chamber—not shown. When the piston 1901 is to the right of the rest position, or switching point, as shown by FIG. 19a, it is influenced by the pressure in the right chamber 1011, and has a resultant force to the left. When the piston 1901 is to the left of the rest position, or switching point, as shown by FIG. 19c, it is influenced by the pressure in the right chamber 1011, and by the pressure in the left chamber 1905. As the effective area of the Force-Barrier 1906 times the pressure in the left chamber 1905 is bigger than the effective area of the piston 1901 times the pressure in the right chamber 1911, the resultant force is to the right. FIG. 19b shows the piston 1901 in the rest position, or switching point.

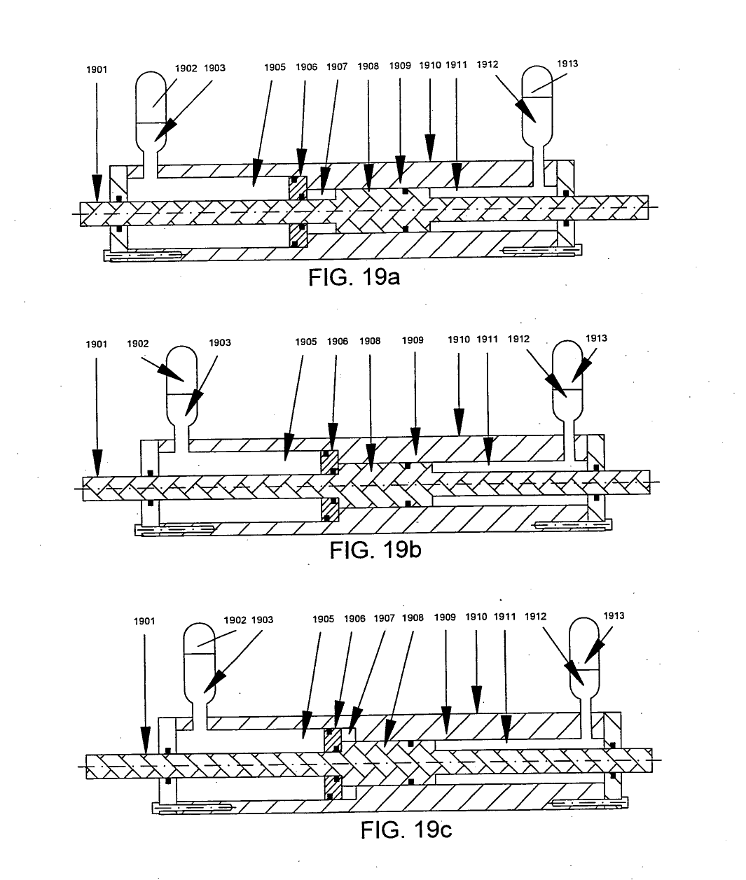

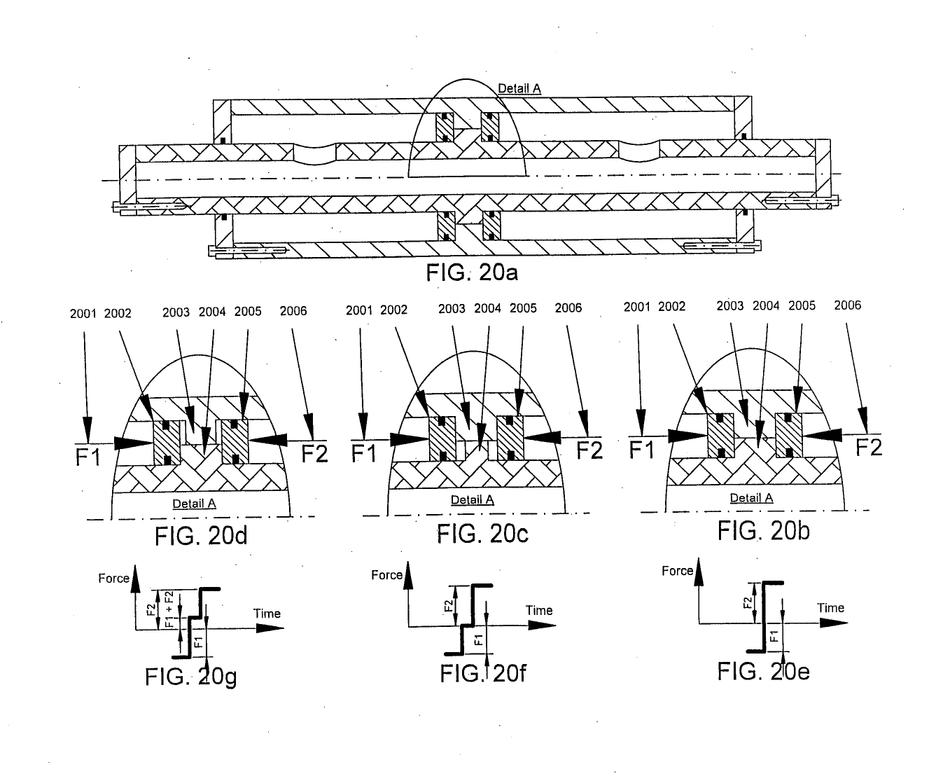

Reference is made to FIG. 20a, FIG. 20b, FIG. 20c, and FIG. 20d.

FIG. 20a shows a cross-section through a rebound-effector having two Force-Barriers, and energized by compressed gas at both sides of a piston. Detail A focuses on the two Force-Barriers, a relatively narrow part of a cylinder, and a relatively wide part of the piston—while being in the rest position, or switching point.

FIG. 20b, FIG. 20c, and FIG. 20d show three relative positions between the relatively narrow part of the cylinder 2003, the relatively wide part of the piston 2004, a left Force-Barrier 2002, and a right Force-Barrier 2005.

FIG. 20b shows the relatively narrow part of the cylinder 2003 and the relatively wide part of the piston 2004 having the same length. At the rest position, or switching point, the left Force-Barrier 2002 and the right Force-Barrier 2005 lie on the relatively narrow part of the cylinder 2003 and on the relatively wide part of the piston 2004. A rightward force on the left Force-Barrier 2002 is indicated as F1 2001. A leftward force on the right Force-Barrier 2005 is indicated as F2 2006. When the piston 2004 crosses the rest position, or switching point, moving from the left to the right, the force pattern on the piston 2004 is as shown by FIG. 20e. The change from being influenced by the force F1 2001, to be influenced by the force F2 2006 is extremely fast, actually, at the speed of voice.

FIG. 20c shows a case where the relatively narrow part of the cylinder 2003 is longer than the relatively wide part of the piston 2004. At the rest position, or switching point, the left Force-Barrier 2002 and the right Force-Barrier 2005 lie on the relatively narrow part of the cylinder 2003, and have no contact with the relatively wide part of the piston 2004. F1 2001 is the rightward force applied on the left Force-Barrier 2002. F2 2006 is the leftward force applied on the right Force-Barrier 2005. When the piston 2004 crosses the rest position, or switching point, moving from the left to the right, the force pattern on the piston 2004 is as shown by FIG. 20f. The change from being influenced by the force F1 2001, to be influenced by no force, is extremely fast, actually, at the speed of voice. Then, after the piston 2004 comes into contact with the right Force-barrier 2005, F2 2006 is very quickly applied on the piston 2004, actually by the speed of voice.

FIG. 20d shows a case where the relatively narrow part of the cylinder 2003 is shorter than the relatively wide part of the piston 2004. At the rest position, or switching point, the left Force-Barrier 2002 and the right Force-Barrier 2005 lie on the relatively wide part of the piston 2004, and have no contact with the relatively narrow part of the cylinder 2003. F1 2001 is the rightward force applied on the left Force-Barrier 2002. F2 2006 is the leftward force applied on the right Force-Barrier 2005. When the piston 2004 crosses the rest position, or switching point, moving from the left to the right, the force pattern on the piston 2004 is as shown by FIG. 20g. The change from being influenced by the force F1 2001, to be influenced by both forces F1 2001 and F2 2006, is very fast, actually, at the speed of voice. Then, after the left Force-Barrier 2002 comes into contact with the relatively narrow part of the cylinder 2003, the piston 2003 is influenced just by the force F2 2006. The change from being influenced by both forces F1 2001 and F2 2006, to be influenced just by the force F2 2006, is very fast, actually by the speed of voice.

The fast applying or removing of the force on or from the piston creates shock-alike force change. This shock develops as fast as a strike of a hammer, enabling a rebound-effector to function as driving, breaking, compacting, vibrating, crushing, and demolishing hammer.

Summarizing, in general, the present invention relates to a Force-Barrier mechanism which applies or removes a load or loads on or from a reciprocating body. The Force-Barrier mechanism includes at least three parts, namely a Force-Barrier body, a reciprocating body, and a static body. The reciprocating body is adapted to reciprocate along a certain path of the static body during operation of the Force-Barrier mechanism, and has at least one step. The force barrier body is adapted to reciprocate along the same path as the reciprocating body reciprocates, or along a part of the path, and has at least one step which is adapted to be laid on the at least one step of the reciprocating body. The static body includes a path for the reciprocating body and/or for the Force-Barrier body, and has at least one step which allows the Force-Barrier body to lie on. Furthermore, the at least one step of the reciprocating body, the static body, and the Force-Barrier body allows for the Force-Barrier body to be laid just on the reciprocating body, just on the static body, or on both the reciprocating body and the static body, at the same time.

If the reciprocating body moves to one direction from the point the force barrier body lies on both the reciprocating body and the static body, the Force-Barrier body stays lying on the static body, and the reciprocating body moves by itself. If the reciprocating body moves to the opposite direction from the point the Force-Barrier body lies on both the reciprocating body and the static body, the Force-Barrier body lies on the reciprocating body, and moves with it.

The reciprocating body, as well as the static body, may have at least one set of steps for supporting at least one Force-Barrier body. Each Force-Barrier body, together with the relevant at least one step on it, on the reciprocating body, and on the static body, functions as described in the foregoing.

The way in which the invention is applied is generally as follows. There is a force applying on the Force-Barrier body. Once the Force-Barrier body lies on the reciprocating body, the force is transferred to the reciprocating body. Once the Force-Barrier body lies on the static body, the force is transferred to the static body. In case the Force-Barrier lies on both the reciprocating body and the static body, the force lies partly on the reciprocating body, and partly on the static body. In case there are more than one Force-Barrier bodies, each of them is loaded by a force, and each of them transfers the force to the reciprocating body, and/or to the static body, as described above.

The Force-Barrier is a very fast force applier and remover on or from a reciprocating body. The Force-Barrier is a completely passive device. It needs no control, and switches the force always at the same location regardless the orientation, type of force, force magnitude, and gravity. In case the reciprocating body is driven by pressurized liquid and/or compressed gas, the Force-barrier is a substitute to a directional valve, or on-off valve, but faster, consuming less energy, and not being in need of control. The Force-Barrier enables the use of at least one spring and/or at least one electro motor in rebound-effectors, linear motors, and other reciprocating devices.

The Force-Barrier may be implemented as a disk placed in between a cylinder and a piston. The cylinder has two internal diameters, and the piston has two external diameters. There is a step between the two diameters of the piston and the two diameters of the cylinder. The Force-Barrier locates in between the large diameter of the cylinder and the small diameter of the piston. It may be laid on the cylinder, on the step between the two diameters, or on the piston, on the step between the two diameters. Force which applies on the Force-Barrier may be transferred to the piston and/or to the cylinder. The change in applying the force from the cylinder to the piston, or vice versa, is done each time the step line of the piston crosses the step line of the cylinder. Removing or adding force from or on the piston changes the resultant force applied on the piston, and therefore changes the dynamics of the piston.

1. A force-barrier mechanism comprising:
a force-barrier body;
a reciprocating body; and
a static body;
wherein the reciprocating body is adapted to reciprocate along a certain path of the static body during operation of the force-barrier mechanism, and has at least one step;
wherein the force-barrier body is adapted to reciprocate along at least a portion of the same path as the reciprocating body reciprocates, and has at least one step which is adapted to be laid on the at least one step of the reciprocating body;
wherein the static body includes a path for one or both of the reciprocating body and force-barrier body, and has at least one step which allows the force-barrier force-barrier body to lie on; and
wherein the at least one step of the reciprocating body, the static body, and the force-barrier body allows for the force-barrier body to be laid just on the reciprocating body, just on the static body, or on both the reciprocating body and the static body.

2. The force-barrier mechanism of claim 1, wherein both the reciprocating body and the static body have at least one set of steps for supporting at least one force-barrier body.

3. The force-barrier mechanism of claim 1, wherein the static body is a cylinder, the reciprocating body is a piston inside the static body, and the at least one force-barrier body is between the static body and the reciprocating body.

4. The force-barrier mechanism of claim 1, wherein the static body is a piston, and the reciprocating body is a cylinder, wherein the static body is inside the reciprocating body, and wherein the at least one force-barrier body is between the static body and the reciprocating body.

5. The force-barrier mechanism of claim 3, comprising at least one force-barrier body for creating, together with at least the static body the reciprocating body, pressurized liquid and/or compressed gas, in at least one chamber.

6. The force-barrier mechanism of claim 5, comprising at least one force-barrier body having at least one of a pressurized liquid, compressed gas, seal, wiper, scraper, and guide.

7. The force-barrier mechanism of claim 5, wherein the at least one chamber comprises at the side opposite to where at least one of the pressurized liquid and compressed gas is pushing, the at least one force-barrier body kept at a pressure which is less than the surrounding atmosphere pressure.

8. The force-barrier mechanism claim 1, further comprising at least one spring for applying force on the at least one force-barrier body.

9. The force-barrier mechanism of claim 1, further comprising at least one moving magnet motor for applying a force on the at least one force-barrier body, wherein the at least one force-barrier body is the at least one magnet of the at least one moving magnet motor.

10. The force-barrier mechanism of claim 1, further comprising at least one electric linear motor or at least one electro magnet for applying a force on the at least one force-barrier body.

11. The force-barrier mechanism of claim 1, wherein two or more force-barrier bodies, which have different applied force sources, and which have different kinds of forces.

12. The force-barrier mechanism of claim 1, further a source for creating a force to be applied on the force-barrier body.

13. The force-barrier mechanism of claim 12, wherein the source for creating a force to be applied on the force-barrier body comprises one or more of a spring, pressurized liquid, a moving magnet motor and compressed gas.
